(19) United States
(12) Patent Application Publication
(10) Pub. No.: US 2007/0160142 A1
(43) Pub. Date: Jul. 12, 2007

(54) Camera and/or Camera Converter

(75) Inventor: Thomas Algie Abrams JR., Snohomish, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/688,807

(22) Filed: Mar. 20, 2007

Related U.S. Application Data
(63) Continuation of application No. 10/116,195, filed on Apr. 2, 2002.

(51) Int. Cl. H04N 7/173; H04N 7/12

(52) U.S. Cl. 375/240.12; 725/105

(57) ABSTRACT

Methods, devices, systems and/or storage media for video and/or audio processing. An exemplary method of controlling a display device includes receiving an executable file and/or code via a network interface, receiving video data via a serial digital interface, executing the executable file and/or code on a runtime engine, processing the video data based at least in part on the executing to produce processed video data and displaying the processed video data. Other exemplary technologies are also disclosed.

### RELATED APPLICATIONS

This application is a continuation application of U.S. patent application Ser. No. 10/116,195, to inventor Thomas Algie Abrams, Jr., filed Apr. 2, 2002 and assigned to Microsoft Corporation ('195 application), which is incorporated herein by reference. This application and the '195 application are related to an application entitled “Video appliance”, to inventors Thomas Algie Abrams, Jr. and Mark Beauchamp, assigned to Microsoft Corporation, filed concurrently on Apr. 2, 2002 and having Ser. No. 10/115,681, which is incorporated herein by reference.

### TECHNICAL FIELD

This invention relates generally to methods, devices, systems and/or storage media for video and/or audio processing.

### BACKGROUND

Video cameras typically produce analog video signals or digital video data suitable for storage and/or display. In general, few options exist as to the nature of the video output by a video camera. For example, most video cameras are committed to a single format, e.g., VHS, NTSC, PAL, etc. In addition, cameras that use compression are often limited to use of a single compression ratio (e.g., such as a set average compression ratio). Further, video cameras are typically discrete elements in an acquisition and/or production process in that control usually occurs at the camera and is effectuated by a cameraman. Overall, a need exists for cameras and/or converters for cameras that allow for greater flexibility and control of video output. Note, as discussed herein, video optionally includes audio.

### SUMMARY

Various exemplary methods, devices and/or systems described herein pertain to video and/or audio acquisition and/or processing. An exemplary method of controlling a video camera includes receiving an executable file and/or code via a network interface, executing the executable file and/or code on a runtime engine, and controlling the video camera based on the executing. Such an exemplary method optionally includes controlling compression ratio to allow for output of video at any of a variety of compression ratios. Another exemplary method includes compressing video at one or more compression ratios and then transmitting the compressed video at one or more bit rates. According to such an exemplary method, the compressed and/or transmitted video may have the same and/or different formats.

An exemplary video camera includes one or more CCDs capable of producing analog signals, a network interface configured to receive code, and a runtime engine configured to execute code received via the network interface wherein execution of the code controls a processor configured to process analog signals produced by the one or more CCDs. Such an exemplary camera optionally includes a serial digital interface wherein execution of the code optionally controls the serial digital interface. In addition, such an exemplary camera optionally includes an analog-to-digital converter wherein execution of the code controls the analog-to-digital converter to convert the analog signals to digital data. Another exemplary camera includes one or more encoders for encoding video at one or more compression ratios. In addition, such a camera optionally includes one or more network interfaces capable of transmitting video at one or more bit rates.

An exemplary converter for a video camera includes a connector to attach and/or electronically connect the converter to the video camera, a network interface configured to receive code, a runtime engine configured to execute code received via the network interface, and a processor configured to process analog signals and/or digital data from the video camera based at least in part on execution of code by the runtime engine. Such an exemplary converter optionally includes a power supply to supply power to the video camera. Further, an exemplary camera, display device and/or converter may have one or more associated network addresses.

Additional features and advantages of the various exemplary methods, devices, systems, and/or storage media will be made apparent from the following detailed description of illustrative embodiments, which proceeds with reference to the accompanying figures.

### BRIEF DESCRIPTION OF THE DRAWINGS

A more complete understanding of the various methods and arrangements described herein, and equivalents thereof, may be had by reference to the following detailed description when taken in conjunction with the accompanying drawings wherein:

FIG. 1 is a block diagram illustrating an exemplary converter for use with or as part of a video camera.

FIG. 2 is a block diagram illustrating the exemplary converter or FIG. 1 in combination with an exemplary analog video camera.

FIG. 3 is a block diagram illustrating the exemplary converter or FIG. 1 in combination with an exemplary analog-to-digital video camera.

FIG. 4 is a block diagram illustrating an exemplary method for processing video data along an analog path and a digital path.

FIG. 5 is a block diagram illustrating another exemplary converter for use with or as part of a video camera.

FIG. 6 is a block diagram illustrating an exemplary method for processing one or more analog signals using one or more compression ratios to produce one or more communicable data streams.

FIG. 7 is a block diagram illustrating an exemplary method for processing two or more analog signals essentially in parallel to produce two or more communicable data streams.

FIG. 8 is a block diagram illustrating an exemplary method for converting information to a particular format using video and/or audio codecs.

FIG. 9 is a block diagram illustrating an exemplary process for compression and decompression of image data.

FIG. 10 is a block diagram of an exemplary converter and a computing device having an associated module.

FIG. 11 is a block diagram illustrating an exemplary display device for receiving, decompressing and displaying video data.

FIG. 12 is a block diagram illustrating an exemplary system that includes one or more camera with converters, one or more networks, one or more clients, and/or one or more display devices.

FIG. 13 is a graph of video data rate in Gbps versus processor speed in GHz for a computer having a single processor.

### DETAILED DESCRIPTION

Turning to the drawings, wherein like reference numerals refer to like elements, various methods are illustrated as being implemented in a suitable computing environment. Although not required, exemplary methods will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that various exemplary methods and converters may be practiced with other computer system configurations, including hand-held devices, multi-processor systems, microprocessor based or programmable consumer electronics, network PCs, minicomputers, mainframe computers, and the like. Various exemplary methods may also be practiced in distributed computing environments where tasks are performed by remote processing devices that are linked through a communications network. In a distributed computing environment, program modules may be located in both local and remote memory storage devices.

In some diagrams herein, various algorithmic acts are summarized in individual “blocks”. Such blocks describe specific actions or decisions that are made or carried out as the process proceeds. Where a microcontroller (or equivalent) is employed, the flow charts presented herein provide a basis for a “control program” or software/firmware that may be used by such a microcontroller (or equivalent) to effectuate the desired control of the stimulation device. As such, the processes are implemented as machine-readable instructions storable in memory that, when executed by a processor, perform the various acts illustrated as blocks.

Those skilled in the art may readily write such a control program based on the flow charts and other descriptions presented herein. It is to be understood and appreciated that the subject matter described herein includes not only devices when programmed to perform the acts described below, but the software that is configured to program the microcontrollers and, additionally, any and all computer-readable media on which such software might be embodied. Examples of such computer-readable media include, without limitation, floppy disks, hard disks, CDs, RAM, ROM, flash memory and the like.

Overview

Various technologies are described herein that pertain generally to analog and/or digital video. Many of these technologies can lessen and/or eliminate the need for a downward progression in video quality. Other technologies allow for new manners of acquisition, processing, distribution and/or display of video. As discussed in further detail below, such technologies include, but are not limited to: exemplary methods for producing a digital video stream and/or a digital video file; exemplary methods for producing a transportable storage medium containing digital video; exemplary methods for displaying digital video; exemplary devices and/or systems for producing a digital video stream and/or a digital video file; exemplary devices and/or systems for storing digital video on a transportable storage medium; exemplary devices and/or systems for displaying digital video; and exemplary storage media for storing digital video.

Various exemplary methods, devices, systems, and/or storage media are described with reference to front-end, intermediate, back-end, and/or front-to-back processes and/or systems. While specific examples of commercially available hardware, software and/or media are often given throughout the description below in presenting front-end, intermediate, back-end and/or front-to-back processes and/or systems, the exemplary methods, devices, systems and/or storage media, are not limited to such commercially available items.

Description of Exemplary Methods, Devices, Systems, and/or Media

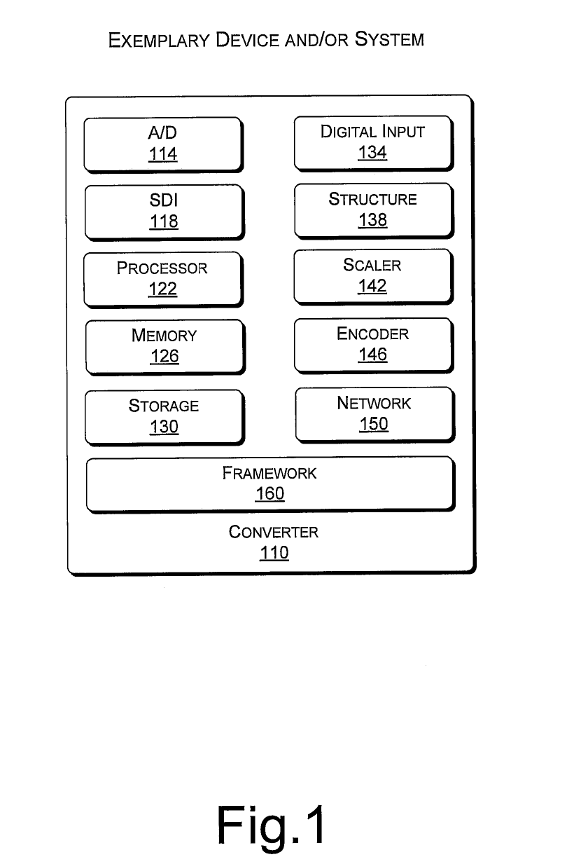

Referring to FIG. 1, a block diagram of an exemplary converter 110 is shown. While FIG. 1 shows a variety of functional blocks, some of the blocks are optional, as discussed in further detail below. The converter 110 includes various functional blocks which are commonly found in a computing environment. With reference to FIG. 1, an exemplary computing environment typically includes a processor or processing unit (e.g., processor block 122), a system memory (e.g., memory block 126), and a system bus that couples various system components including the system memory to the processing unit. The system bus may be any of several types of bus structures including a memory bus or memory controller, a peripheral bus, and a local bus using any of a variety of bus architectures. The system memory (e.g., the memory block 126) includes read only memory (ROM) and random access memory (RAM). A basic input/output system (BIOS), containing the basic routines that helps to transfer information between elements within the computing environment, such as during start-up, is stored in ROM. The exemplary computing environment further optionally includes storage (e.g., storage block 130), such as, a hard disk drive for reading from and writing to a hard disk, a magnetic disk drive for reading from or writing to a removable magnetic disk, and an optical disk drive for reading from or writing to a removable optical disk such as a CD ROM or other optical media. The hard disk drive, magnetic disk drive, and optical disk drive are typically connected to the system bus by a hard disk drive interface, a magnetic disk drive interface, and an optical drive interface, respectively. The drives and their associated computer-readable media provide nonvolatile storage of computer readable instructions, data structures, program modules and other data for the computing environment. Although the exemplary environment described herein employs a hard disk, a removable magnetic disk and a removable optical disk, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROM), and the like, may also be used in the exemplary operating environment.

In accordance with the exemplary computing environment, a number of program modules may be stored on the hard disk, magnetic disk, optical disk, ROM or RAM, including an operating system, one or more application programs, other program modules, and program data. A user may enter commands and information into exemplary computing environment through input devices such as a keyboard and pointing device. Other input devices may include a microphone, joystick, game pad, satellite dish, scanner, or the like. These and other input devices are often connected to the processing unit through a serial port interface that is coupled to the system bus, but may be connected by other interfaces, such as a parallel port, game port or a universal serial bus (USB).

The exemplary computing environment may exist in a networked environment using logical connections to one or more remote computers. A remote computer may be a personal computer, a server, a router, a network PC, a peer device or other common network node. The logical connections optionally include a local area network (LAN) and a wide area network (WAN). Such networking environments are commonplace in offices, enterprise-wide computer networks, intranets and the Internet.

When used in a LAN networking environment, an exemplary converter (e.g., the converter 110) is connected to the local network through a network interface or adapter. When used in a WAN networking environment, an exemplary converter (e.g., the converter 110) typically includes a modem or other means for establishing communications over the wide area network, such as the Internet. In a networked environment, program modules may be stored in a remote memory storage device. It will be appreciated that the network connections shown are exemplary and other means of establishing a communications link between computing environments (e.g., exemplary converters) may be used.

Referring again to FIG. 1, the converter 110 includes an analog-to-digital conversion block 114 that can convert an analog signal to a digital signal. An exemplary conversion block 114 includes an analog-to-digital converter for receiving and converting standard or non-standard analog camera video signals to digital video data. A digital input block 134 includes a digital interface for receiving standard or non-standard digital video data. While a separate serial digital interface (SDI) block 118 (or digital serial interface) is shown, the digital input block 134 optionally includes a serial digital interface. The analog signals and/or digital data received by the analog-to-digital conversion block 114 and/or digital input block 134 optionally include timing, audio and/or other information related to video signals and/or data received.

The analog-to-digital conversion block 114 and the digital input block 134 may receive monochrome (e.g., black and white) and/or polychrome (e.g., at least two component color) video signals or data. Polychrome video (referred to herein as color video) typically adheres to a color space specification. A variety of color space specifications exist, including, but not limited to, RGB, “Y, B-Y, R-Y”, YUV, YPbPr and YCbCr, which are typically divided into analog and digital specifications. For example, YCbCr is associated with digital specifications (e.g., CCIR 601 and 656) while YPbPr is associated with analog specifications (e.g., EIA-770.2-a, CCIR 709, SMPTE 240M, etc.). The YCbCr color space specification has been described generally as a digitized version of the analog YUV and YPbPr color space specifications; however, others note that CbCr is distinguished from PbPr because in the latter the luma and chroma excursions are identical while in the former they are not. The CCIR 601 recommendation specifies an YCbCr color space with a 4:2:2 sampling format for two-to-one horizontal subsampling of Cb and Cr, to achieve approximately ⅔ the data rate of a typical RGB color space specification. In addition, the CCIR 601 recommendation also specifies that: 4:2:2 means 2:1 horizontal downsampling, no vertical downsampling (4 Y samples for every 2 Cb and 2 Cr samples in a scanline); 4:1:1 typically means 4:1 horizontal downsampling, no vertical downsampling (4 Y samples for every 1 Cb and 1 Cr samples in a scanline); and 4:2:0 means 2:1 horizontal and 2:1 vertical downsampling (4 Y samples for every Cb and Cr samples in a scanline.). The CCIR 709 recommendation includes an YPbPr color space for analog HDTV signals while the YUV color space specification is typically used as a scaled color space in composite NTSC, PAL or S-Video. Overall, color spaces such as YPbPr, YCbCr, PhotoYCC and YUV are mostly scaled versions of “Y, B-Y, R-Y” that place extrema of color difference channels at more convenient values.

As mentioned, reception of analog signals and/or digital data in non-standard color specifications is also optionally possible. Further, reception of color signals according to a yellow, green, magenta, and cyan color specification is also optionally possible. Some video cameras that rely on the use of a CCD (or CCDs) output analog signals containing luminance and color difference information. For example, one particular scheme uses a CCD that outputs raw signals corresponding to yellow (Ye), green (G), magenta (Mg) and cyan (Cy). A sample and hold circuit associated with the CCD typically derives two raw analog signals (e.g., S₁ and S₂). Other circuits associated with the CCD typically include an amplifier (or preamplifier), a correlated double sampling (CDS) circuit, and an automatic gain controller (AGC). Once the raw analog signals S₁ and S₂ have been derived, a process known as color separation is used to convert the raw analog signals, which are typically pixel pairs, to luminance and color difference. Accordingly, a luminance may equal (Mg+Ye)+(G+Cy), which corresponds to Y₀₁; a blue component may equal −(Ye+G)+(Cy+Mg), which corresponds to C₀; and a red component may equal (Mg+Y2)−(G+Cy), which corresponds to C₁. As described further herein, the luminance Y₀₁ and chrominance signals C₀ and C₁ can be further processed to determine: R, G, and B; R-Y and B-Y; and a variety of other signals and/or data according to a variety of color specifications.

In general, an exemplary analog-to-digital converter suitable for use in the analog-to-digital conversion block 114 converts each analog signal to digital data having a particular bit depth. For example, commonly used bit-depths include, but are not limited to, 8 bits, 10 bits, and 12 bits; thus, corresponding RGB digital data would have overall bit-depths of 24 bits, 30 bits and 36 bits, respectively. Often, an analog-to-digital converter will have at least two analog inputs and typically at least three analog inputs.

Referring again to FIG. 1, the converter 110 also optionally includes a structure block 138 for structuring data received through the analog-to-digital conversion block 114 and/or the digital input block 134. In general, the structure block 138 structures digital video data. For example, the structure block 138 optionally structures digital video data to a digital video format suitable for encoding or compressing by an encoder block 146; to a digital video format suitable for communication through the digital serial interface block 118 and/or a network interface block 150; and/or to a digital video format suitable for storage in a storage block 130, e.g., as a file or files.

The converter 110 also optionally includes a scaler block 142. The scaler block 142 optionally scales digital video data; whereas, scaling of analog video data is possible in the analog-to-digital conversion block 114. The scaler block 142 may scale digital video data prior to and/or after structuring. In general, scaling is performed to typically reduce video resolution, color bit depth, and/or color sampling format.

As shown in FIG. 1, the converter 110 includes an encoder block 146. The encoder block 146 includes a compression algorithm suitable for compressing digital video data and/or digital audio data. In general, compressed digital video data has a format suitable for communication through the serial digital interface block 118 and/or the network interface block 150; and/or for storage in the storage block 130, e.g., as a file or files. Exemplary encoder schemes using various compression algorithms are discussed in more detail further below.

As already mentioned, the converter 110 includes a network interface block 150 and/or a serial digital interface (SDI) block 118. These two blocks are capable of communicating digital video data at a variety of bit rates according to standard and/or non-standard communication specifications. For example, the SDI block 118 optionally communicates digital video data according to an SMPTE specification (e.g., SMPTE 259M, 292M, etc.). The SMPTE 259M specification states a bit rate of approximately 270 Mbps and the SMPTE 292M specification states a bit rate of approximately 1.5 Gbps. The network interface block 150 optionally communicates digital video data according to a 100-Base-T specification (e.g., approximately 100 Mbps). Of course, a variety of other suitable network interfaces also exist, e.g., 100VG-AnyLAN, etc., some of which may be capable of bit rates lower or higher than approximately 100 Mbps.

The exemplary converter 110, as shown in FIG. 1, also includes a framework block 160, which indicates that the converter 110 has framework capabilities. In general, a framework is associated with capabilities such as a “runtime engine” (RE) or “virtual machine” (VE). In object-oriented programming, the terms “virtual machine” and “runtime engine” (RE) have recently become associated with software that executes code on a processor or a hardware platform. In the description presented herein, the term “RE” includes VM. A RE often forms part of a larger system or framework that allows a programmer to develop an application for a variety of users in a platform independent manner. For a programmer, the application development process usually involves selecting a framework, coding in an object-oriented programming language associated with that framework, and compiling the code using framework capabilities. The resulting typically platform-independent, compiled code is then made available to users, usually as an executable file and typically in a binary format. Upon receipt of an executable file, a user can execute the application on a RE associated with the selected framework. As discussed herein, an application (e.g., in the form of compiled code) is optionally provided from and/or to various units and executed one or more of such units using a RE associated with the selected framework. In general, a RE interprets and/or compiles and executes native machine code/instructions to implement an application or applications embodied in a bytecode and/or an intermediate language code (e.g., an IL code). Further, as discussed herein, a controller optionally serves code to a converter, a camera and/or a display. In addition, an exemplary converter may serve code to a controller and/or other device associated with video production and/or broadcasting.

In general, a framework has associated classes which are typically organized in class libraries. Classes can provide functionality such as, but not limited to, input/output, string manipulation, security management, network communications, thread management, text management, and other functions as needed. Data classes optionally support persistent data management and optionally include SQL classes for manipulating persistent data stores through a standard SQL interface. Other classes optionally include XML classes that enable XML data manipulation and XML searching and translations. Often a class library includes classes that facilitate development and/or execution of one or more user interfaces (UIs) and, in particular, one or more graphical user interfaces (GUIs).

As described herein, a framework RE optionally acts as an interface between applications and an operating system. Such an arrangement can allow applications to use the operating system advantageously. As already mentioned, such a framework typically includes object-oriented programming technologies and/or tools, which can further be partially and/or totally embedded. Such frameworks include, but are not limited to, the .NET® framework (Microsoft Corporation, Redmond, Wash.), the ACTIVEX® framework (Microsoft Corporation), and the JAVA® framework (Sun Microsystems, Inc., San Jose, Calif.). In general, such frameworks rely on a runtime engine for executing code. Further, exemplary converters, which are capable of operating with a framework, are generally extensible and flexible. For example, such a converter is characterized by a ready capability to adapt to new, different, and/or changing requirements and by a ready capability to increase scope and/or application.

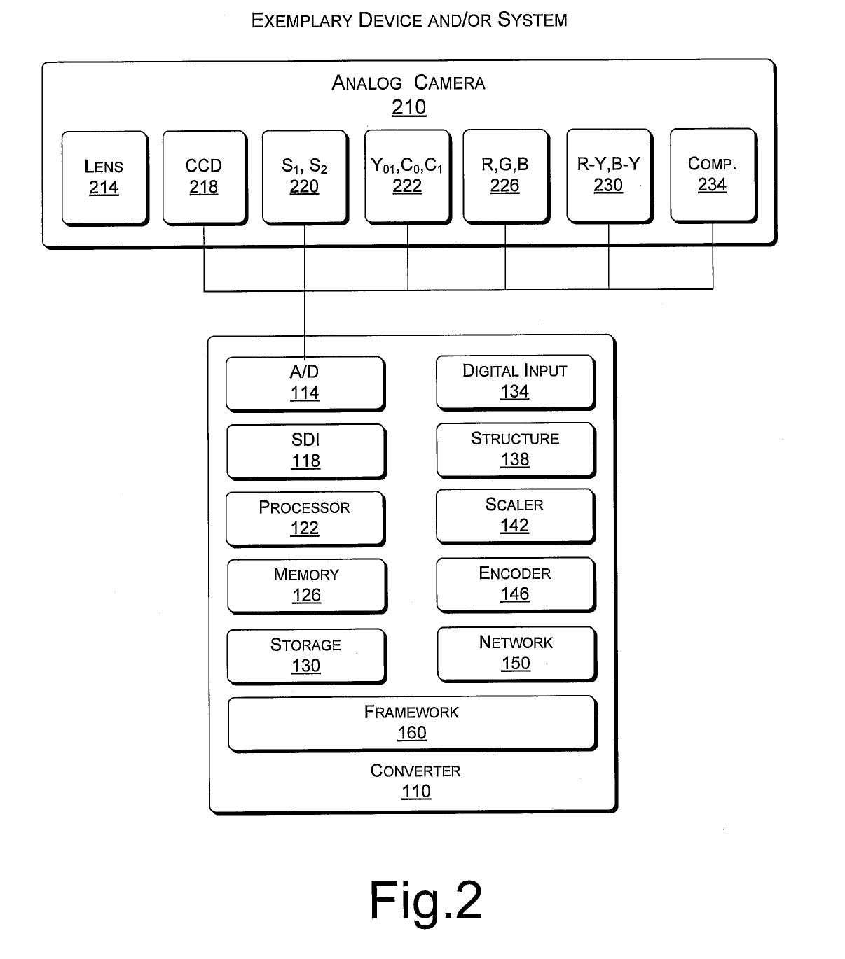

Referring to FIG. 2, the converter 110 is shown in conjunction with an analog camera 210. The analog camera 210 includes a variety of exemplary analog video signal blocks and other blocks. A lens block 214 includes a lens for receiving photons and allowing for transmission of the photons to a CCD block 218. An analog camera (or an analog-to-digital camera) may have one or more CCD blocks. For example, professional video cameras typically include three CCD blocks, e.g., one for a red signal, one for a blue signal, and one for a green signal. In such cameras, a prism or other arrangement of optical elements is used to split a signal into component colors and then direct the component colors to respective CCDs.

The analog video signal blocks include a S₁, S₂ signal block 220; an Y₀₁, C₀, C₁ signal block 222; an R, G, B signal block 226; an R-Y, B-Y signal block 230, and a composite signal block 234. These analog signal blocks, if present, are capable of communicating with the converter 110 wherein, the analog-to-digital conversion block 114 optionally receives any one of these analog signals. While not shown, the analog-to-digital conversion block 114 may also receive other signals, such as, but not limited to, timing, audio, etc.

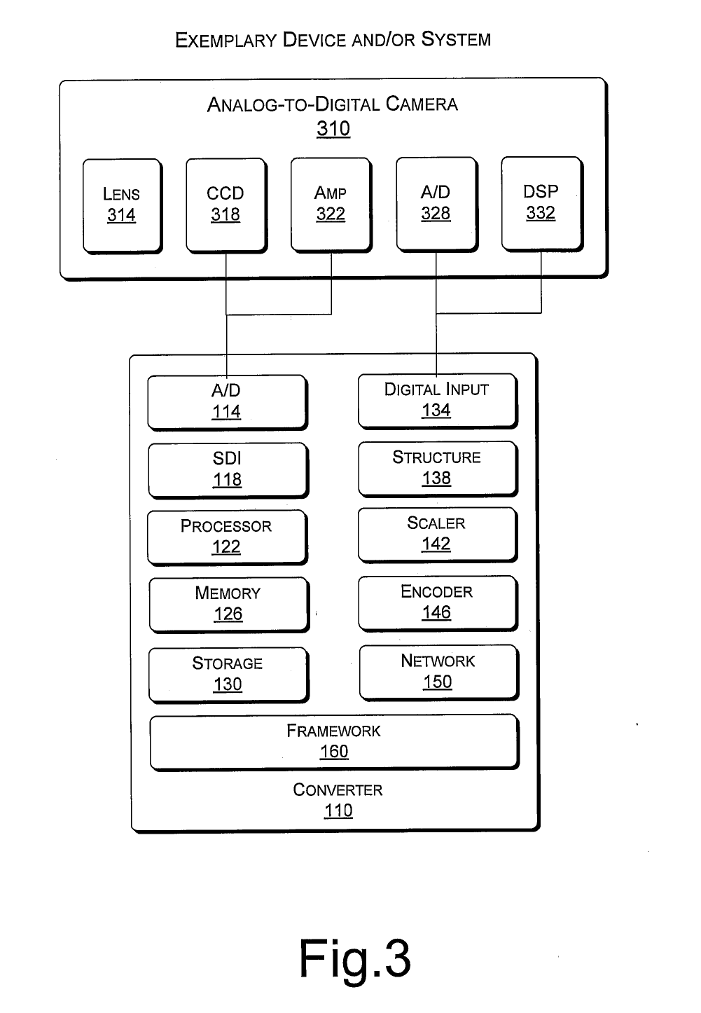

Referring to FIG. 3, the converter 110 is shown in conjunction with an analog-to-digital camera 310. The analog-to-digital camera 310 includes a variety of exemplary blocks. A lens block 314 includes a lens for receiving photons and allowing for transmission of the photons to a CCD block 318. An analog-to-digital camera may have one or more CCD blocks. For example, professional video cameras typically include three CCD blocks, e.g., one for a red signal, one for a blue signal, and one for a green signal. In such cameras, a prism or other arrangement of optical elements is used to split a signal into component colors and then direct the component colors to respective CCDs.

The other blocks shown within the analog-to-digital camera 310 are responsible for a variety of signal and/or data processing. For example, an amplifier block 322 includes an amplifier to amplify a CCD signal prior to further processing. An analog-to-digital conversion block 328 includes an analog-to-digital converter that is capable of converting an analog video signal to digital video data. A digital signal processing (DSP) block 332 includes various circuits and/or software for digital signal processing. Of course, an exemplary converter optionally includes DSP features and/or a DSP block. DSP includes processing of digital video data into any of a variety of video formats. Exemplary formats pertain to resolution, frame rate, color space specification, color sampling format, bit depth, etc. In general, a digital video format that specifies resolution, frame rate, color sampling format and bit depth allows for determination of a bit rate.

Exemplary connectors are also shown in FIG. 3, connecting the CCD block 318 and the amplifier block 322 to the analog-to-digital conversion block 114 and connecting the analog-to-digital conversion block 318 (of the camera 310) and the DSP block 332 to the digital input block 134. Hence, according to the exemplary converter 110 and camera 310 arrangement shown in FIG. 3, the converter 110 can received analog signals and/or digital data from an analog-to-digital camera. Of course, as already mentioned, the analog signals and/or digital data are not limited to video; such signals and/or data may also include timing information, audio, etc.

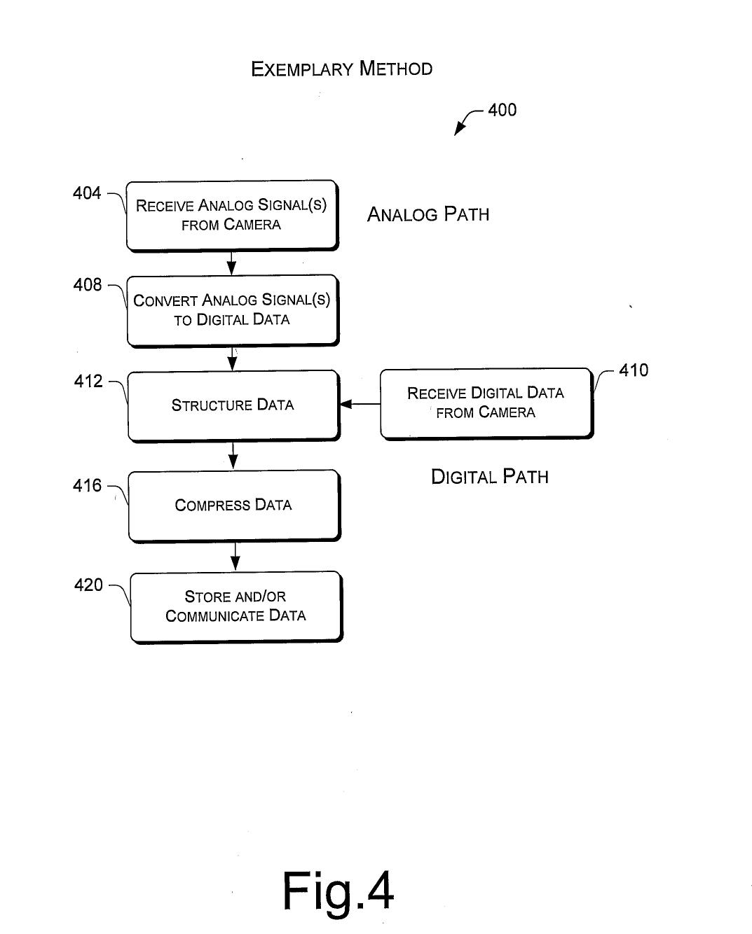

Referring to FIG. 4, an exemplary method of processing analog video signals (analog path) and/or digital video data (digital path) 400 is shown. According an analog path of the exemplary method 400, in a reception block 404, a converter receives one or more analog signals from a video camera. Next, in a conversion block 408, the converter converts the one or more analog signals to digital data. As mentioned previously, this conversion includes use of an analog-to-digital converter, which optionally includes a frame grabber or frame grabber technology. Suitable analog-to-digital conversion boards and/or frame grabber boards exist and are commercially available. In addition, such boards typically include software for performing a variety of operations related to video format and/or audio format.

The digital path does not include an analog-to-digital conversion within the converter (e.g., the converter 110). The digital path commences in a reception block 410 wherein the converter receives digital data from a camera. The digital path and the analog path converge in the sense that both include a structure block 412. In the structure block 412, the converter converts digital data to a format suitable for reception by an encoder. Of course, in an alternative exemplary method, a camera may optionally structure digital data prior to receipt by a converter and thereby alleviate the need for structuring by the converter. Next, in an encode block 416, the converter compresses the data using the encoder to produce compressed data. The degree of compression, or compression ratio is typically determined by future use, communication bandwidth, and/or storage capabilities. In addition, the compressed data optionally includes audio and/or other information. The compressed data is further typically suitable for communication via a SDI and/or a network interface and/or for storage to a storage medium. Indeed, in a store and/or a communicate block 420, the converter stores and/or communicates the compressed data.

The exemplary method 400 optionally includes requesting and/or receiving of code from a controller and/or other device. For example, an exemplary converter may request a control command from a controller wherein the command specifies receiving, conversion, structuring, compression, storage and/or communication parameters for use in the blocks 404-420. In turn, a controller may transmit code to the exemplary converter where, upon receipt, the converter executes the code using framework capabilities.

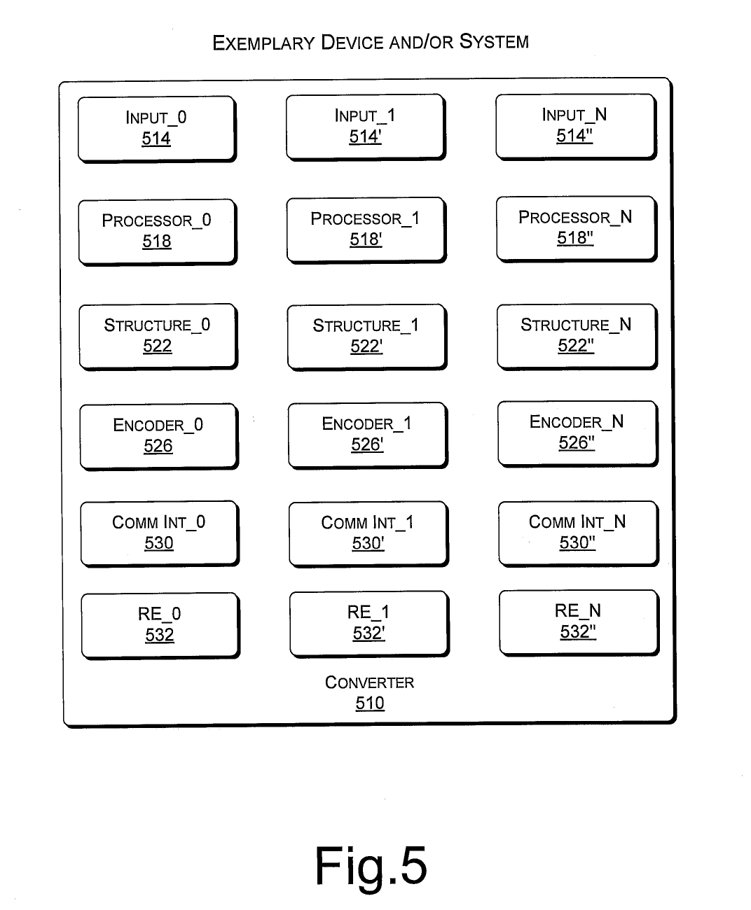

In general, the arrangements shown in FIGS. 1 through 3, allow for receipt of an analog video signal or signals and/or digital video data corresponding to one processing point in a camera. For example, the analog path of the exemplary method 400 may correspond to receipt of analog video signals from an R, G, B block of an analog camera (see, e.g., the R, G, B block 226 of FIG. 2); whereas, the digital path of the exemplary method 400 may correspond to receipt of digital video data from a DSP of an analog-to-digital camera (see, e.g., the DSP block 332 of FIG. 3). In addition, it is, at times, desirable to communicate compressed data in real-time and/or near real-time. The converter 110 shown in FIGS. 1 through 3 is capable of such performance; however, if an analog signal and/or digital data are received from more than one processing point in a camera, then real-time and/or near real-time processing may require additional hardware and/or software. Further, the arrangements shown in FIGS. 1 through 3, typically allow for output of compressed data at only one specified bit rate (whether constant or variable). Thus, as shown in FIG. 5, an exemplary converter 510 includes additional functionality to allow for receipt of signals and/or data from more than one processing point and/or to allow for communication of compressed data over various communication links and/or at a variety of communication bit rates. Referring to FIG. 5, a block diagram of an exemplary converter 510 is shown. The exemplary converter 510 optionally includes some or all of the blocks shown in the exemplary converter 110 of FIGS. 1 through 3. For example, the converter 510 includes input, processor, structure, encoder, and communication interface blocks. Input blocks include Input_0 (514), Input_1 (514′) and Input_N (514″) (where “N” is any integer greater than 1), which optionally include features of the analog-to-digital conversion block 114 and/or the digital input block 134 of the converter 110. Of course, an exemplary converter having two of such input blocks is possible. Processor blocks include Processor_0 (518), Processor_1 (518′) and Processor_N (519″) (where “N” is any integer greater than 1), which optionally include features of the processor block 122 of the converter 110. Of course, an exemplary converter having two of such processor blocks is possible. Structure blocks include Structure_0 (522), Structure_1 (522′) and Structure_N (522″) (where “N” is any integer greater than 1), which optionally include features of the structure block 138 of the converter 110. Of course, an exemplary converter having two of such structure blocks is possible. Encoder blocks include Encoder_0 (526), Encoder_1 (526′) and Encoder_N (526″) (where “N” is any integer greater than 1), which optionally include features of the encoder block 146 of the converter 110. Of course, an exemplary converter having two of such encoder blocks is possible. Communication interface blocks include Comm Int_0 (530), Comm Int_1 (530′) and Comm Int_N (530″) (where “N” is any integer greater than 1), which optionally include features of the SDI block 118 and/or the network interface block 150 of the converter 110. Of course, an exemplary converter having two of such communication interface blocks is possible. The exemplary converter 510 also includes one or more RE blocks, e.g., RE_0 (532), RE_1 (532′) and RE_N (532″) (where “N” is any integer greater than 1). Such RE blocks optionally receive and execute code to affect operation of other functional blocks.

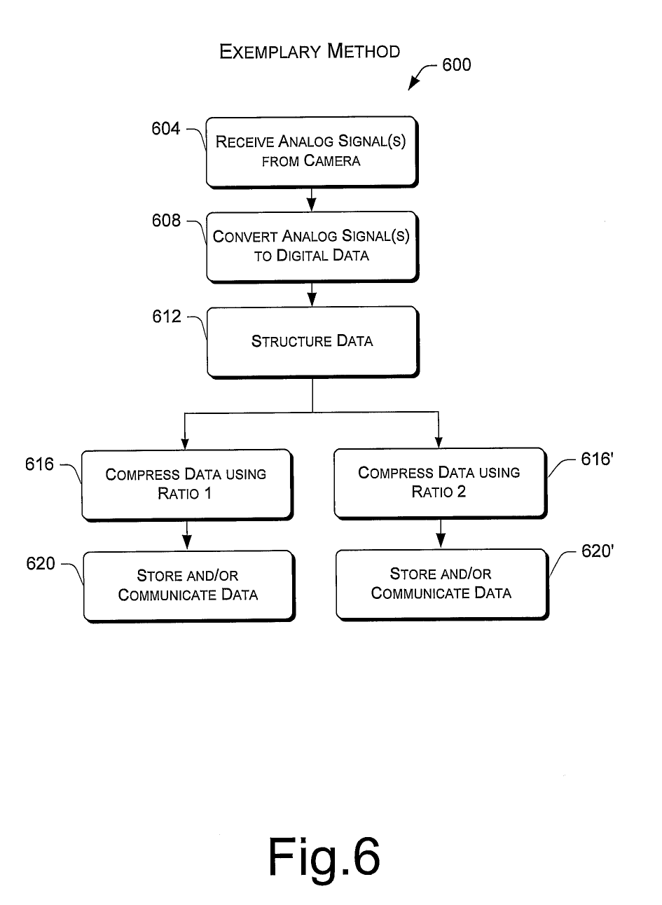

A block diagram of an exemplary method of using the converter 510 of FIG. 5 is shown in FIG. 6. In a reception block 604, a converter (e.g., the converter 510) receives one or more analog signals from a video camera. Next, in a conversion block 608, the converter converts the one or more analog signals to digital data. In the structure block 612, the converter converts the digital data to a format suitable for reception by one or more encoders. Next, in one encode block 616, the converter compresses the data using one encoder to produce compressed data and, in another encode block 616′, the converter compresses the data using another encoder to produce compressed data. Each encoder compresses the data from the structure block 612 using a specific and/or an average compression ratio. For example, as shown in FIG. 6, the encode block 616 uses Ratio 1; whereas, the encode block 616′ uses Ratio 2. Ratio 1 and Ratio 2 may be approximately equal or may differ. Again, the degree of compression, or compression ratio is typically determined by future use, communication bandwidth, and/or storage capabilities. In addition, the compressed data optionally includes audio and/or other information. The compressed data is further typically suitable for communication via a SDI and/or a network interface and/or for storage to a storage medium. Indeed, in one store and/or communicate block 620, the converter stores and/or communicates the compressed data compressed using Ratio 1 while in another store and/or communicate block 620′, the converter stores and/or communicates the compressed data compressed using Ratio 2.

According to the exemplary method 600, the converter can optionally communicate data at two different bit rates to suit two different situations. For example, one client may have a communication link having a bandwidth of approximately 5 Mbps while another client may have a communication link having a bandwidth of approximately 10 Mbps. Thus, the exemplary method allows for compression of video at two different compression ratios and transmission of compressed digital video data at two different bit rates. In addition, the converter 510 and/or method 600 allow for simultaneous (or nearly simultaneous) communication of two digital bit streams. Further, the communication may occur in real-time and/or near real-time. Thus, a client receiving a feed from a camera and a client (or clients) receiving a feed from a converter do not necessarily perceive a time delay. Of course, in general, the higher bandwidth communication contains more information and typically higher quality video.

The exemplary method 600 optionally includes requesting and/or receiving of code from a controller and/or other device. For example, an exemplary converter may request a control command from a controller wherein the command specifies receiving, conversion, structuring, compression, storage and/or communication parameters for use in the blocks 604-620. In turn, a controller may transmit code to the exemplary converter where, upon receipt, the converter executes the code using framework capabilities.

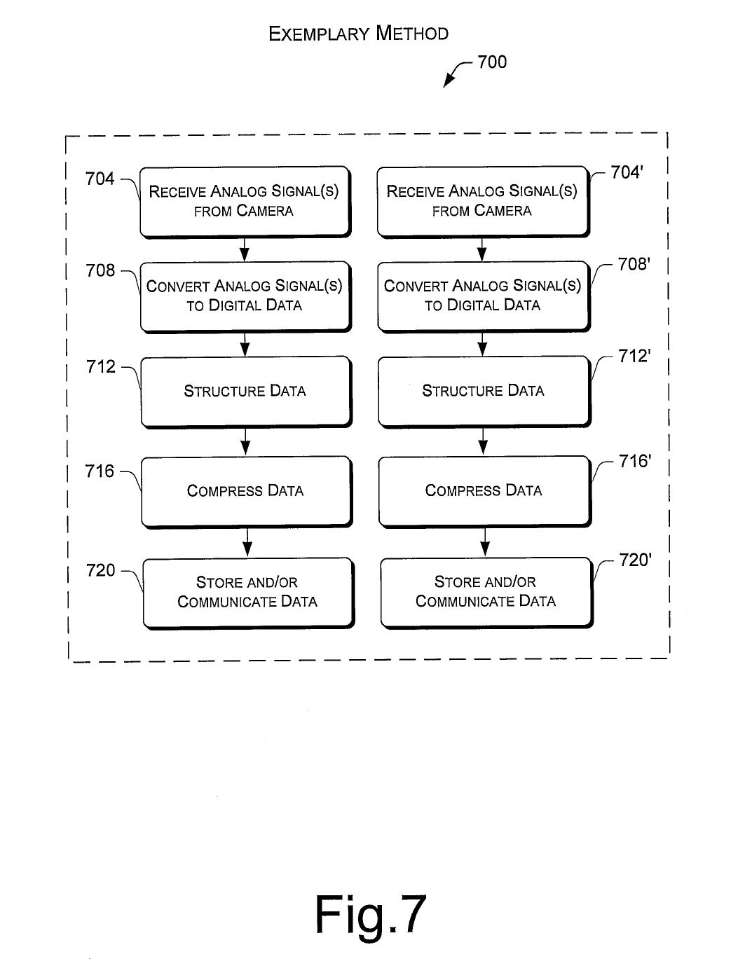

Referring to FIG. 7, a block diagram of another exemplary method of using the converter 510 of FIG. 5 is shown. In one reception block 704, a converter (e.g., the converter 510) receives one or more analog signals from one processing point in a video camera. In another reception block 704′, the converter receives one or more analog signals from another processing point in the video camera. Two conversion blocks 708, 708′ follow wherein the converter converts the analog signals to digital data. In two structure blocks 712, 712′, the converter structures the digital data from each respective conversion block 708, 708′. In the structure blocks 712, 712′ the converter converts the digital data to a format suitable for reception by an encoder. Next, in one encode block 716, the converter compresses the data using one encoder to produce compressed data and, in another encode block 716′, the converter compresses the data using another encoder to produce compressed data. Each encoder compresses the data from a respective structure block 712, 712′ using a specific and/or an average compression ratio. For example, the encode block 716 uses Ratio 1; whereas, the encode block 716′ uses Ratio 2. Ratio 1 and Ratio 2 may be approximately equal or may differ. Again, the degree of compression, or compression ratio is typically determined by future use, communication bandwidth, and/or storage capabilities. In addition, the compressed data optionally includes audio and/or other information. The compressed data is further typically suitable for communication via a SDI and/or a network interface and/or for storage to a storage medium. As shown in FIG. 7, in one store and/or communicate block 720, the converter stores and/or communicates the compressed data compressed using one encoder while in another store and/or communicate block 720′, the converter stores and/or communicates the compressed data compressed using another encoder. While the exemplary method 700 shows two reception blocks 704, 704′ for reception of analog signal, another exemplary method includes two reception blocks for reception of digital data and yet another exemplary method includes one reception block for reception of digital data and another reception block for reception of analog signals. Of course, a converter that implements more than two receptions blocks is possible.

The exemplary method 700 optionally includes requesting and/or receiving of code from a controller and/or other device. For example, an exemplary converter may request a control command from a controller wherein the command specifies receiving, conversion, structuring, compression, storage and/or communication parameters for use in the blocks 704-720 and/or 704′-720′. In turn, a controller may transmit code to the exemplary converter where, upon receipt, the converter executes the code using framework capabilities.

To understand better performance characteristics of exemplary converters and/or methods described herein, specific non-limiting examples are given along with exemplary hardware and/or software for encoding.

Exemplary NTSC Converter

A standard NTSC analog color video format includes a frame rate of approximately 30 frames per second (fps), a vertical line resolution of approximately 525 lines, and 640 active pixels per line. Note that the horizontal size of an image (in pixels) from an analog signal is generally determined by a sampling rate, which is the rate that the analog-to-digital conversion samples each horizontal video line. The sampling rate is typically determined by the vertical line rate and the architecture of the camera. Often, the CCD array determines the size of each pixel. To avoid distorting an image, the sampling rate must sample in the horizontal direction at a rate that discretizes the horizontal active video region into the correct number of pixels. For purposes of this example, consider a converter having an analog-to-digital converter that converts analog video having the aforementioned NTSC format to digital video having a resolution of 640 pixels by 480 lines, a frame rate of 30 fps and an overall bit depth of approximately 24 bits. The resulting bit rate for this digital video data is approximately 220 Mbps.

According to this exemplary converter and method of conversion, after conversion of the analog video to digital video data, the converter then structures the data in a format suitable for input to an encoder, which then compresses the digital video data at a specific and/or an average compression ratio. For example, given a data rate of approximately 220 Mbps, a compression ratio of approximately 50:1 would reduce the data rate to approximately 4.4 Mbps.

Now consider an exemplary converter having at least two encoders. Such an exemplary converter may use one encoder to compress the digital video data at a ratio of approximately 400:1 and use another encoder to compress the digital video data at a ratio of approximately 50:1. According to this example, the converter is capable of communicating compressed digital data at a rate of approximately 550 kbps and also communicating compressed digital data at a rate of approximately 4.4 Mbps. In this example, the lower data rate compressed data may be communicated to a plurality of clients over one network while the higher data rate compressed data may be communicated to a single client over an exclusive network. Further, every network interface of the converter optionally has an associated address (e.g., an IP address, etc.). Thus, clients may gain access to compressed data over a network via the address.

Exemplary PAL Converter

A standard PAL analog color video format includes a frame rate of approximately 25 frames per second (fps), a vertical line resolution of approximately 625 lines, and 768 active pixels per line. Consider an exemplary converter that receives analog video according to this format via an analog-to-digital converter having an appropriate analog interface. In this example, the analog-to-digital converter converts the analog video to digital video data having a resolution of 768 pixels by 576 lines, a frame rate of approximately 25 fps, and an overall color bit-depth of approximately 24 bits. Data in this format has a corresponding data rate of approximately 270 Mbps.

According to this exemplary converter and method of conversion, after conversion of the analog video to digital video data, the converter then structures the data in a format suitable for input to an encoder, which then compresses the digital video data at a specific and/or an average compression ratio. For example, given a data rate of approximately 270 Mbps, a compression ratio of approximately 50:1 would reduce the data rate to approximately 5.3 Mbps.

Now consider an exemplary converter having at least two encoders. Such an exemplary converter may use one encoder to compress the digital video data at a ratio of approximately 400:1 and use another encoder to compress the digital video data at a ratio of approximately 50:1. According to this example, the converter is capable of communicating compressed digital data at a rate of approximately 660 kbps and also communicating compressed digital data at a rate of approximately 5.3 Mbps. In this example, the lower data rate compressed data may be communicated to a plurality of clients over one network while the higher data rate compressed data may be communicated to a single client over an exclusive network. Further, every network interface of the converter optionally has an associated address (e.g., an IP address, etc.). Thus, clients may gain access to compressed data over a network via the address.

Exemplary Non-Standard Resolution Converter

An analog or an analog-to-digital camera may include a CCD having a non-standard resolution. For example, CCDs exist having resolutions of 1292 pixel by 966 pixel; 2470 pixel by 1652 pixel, etc. Consider an exemplary converter that receives digital video data according to a format having a resolution of 1292 pixel by 966 pixel, a frame rate of approximately 24 fps, and an overall color bit-depth of approximately 24 bits. Data in this format has a corresponding data rate of approximately 720 Mbps.

According to this exemplary converter and method of conversion, after receiving the digital video data, the converter then structures the data in a format suitable for input to an encoder, which then compresses the digital video data at a specific and/or an average compression ratio. For example, given a data rate of approximately 720 Mbps, a compression ratio of approximately 100:1 would reduce the data rate to approximately 7.2 Mbps.

Now consider an exemplary converter having at least two encoders. Such an exemplary converter may use one encoder to compress the digital video data at a ratio of approximately 500:1 and use another encoder to compress the digital video data at a ratio of approximately 100:1. According to this example, the converter is capable of communicating compressed digital data at a rate of approximately 1.4 Mbps and also communicating compressed digital data at a rate of approximately 7.2 Mbps. In this example, the lower data rate compressed data may be communicated to a plurality of clients over one network while the higher data rate compressed data may be communicated to a single client over an exclusive network. Further, every network interface of the converter optionally has an associated address (e.g., an IP address, etc.). Thus, clients may gain access to compressed data over a network via the address.

Other Formats

The various exemplary converters and/or method described herein are not limited to specific analog or digital formats. Regarding digital video formats, Table 1, below, presents several commonly used digital video formats, including 1080×1920, 720×1280, 480×704, and 480×640, given as number of lines by number of pixels.

TABLE 1
Common Digital Video Formats

| | | | Frame Rate | Sequence |
|---|---|---|---|---|
| Lines | Pixels | Aspect Ratio | s⁻¹ | p or i |
| 1080 | 1920 | 16:9 | 24, 30 | progressive |
| 1080 | 1920 | 16:9 | 30, 60 | interlaced |
| 720 | 1280 | 16:9 | 24, 30, 60 | progressive |
| 480 | 704 | 4:3 or 16:9 | 24, 30, 60 | progressive |
| 480 | 704 | 4:3 or 16:9 | 30 | interlaced |
| 480 | 640 | 4:3 | 24, 30, 60 | progressive |
| 480 | 640 | 4:3 | 30 | interlaced |

Regarding high definition television (HDTV), formats generally include 1,125 line, 1,080 line and 1,035 line interlace and 720 line and 1,080 line progressive formats in a 16:9 aspect ratio. According to some, a format is high definition if it has at least twice the horizontal and vertical resolution of the standard signal being used. There is a debate as to whether 480 line progressive is also “high definition”; it provides better resolution than 480 line interlace, making it at least an enhanced definition format. Various exemplary methods, devices, systems and/or storage media presented herein cover such formats and/or other formats.

Another exemplary video standard not included in Table 1 is for video having a resolution of 1920 pixel by 1080 line, a frame rate of 24 fps, a 10-bit word and RGB color space with 4:2:2 sampling. Such video has on average 30 bits per pixel and an overall bit rate of approximately 1.5 Gbps. Yet another exemplary video standard not included in Table 1 is for video having a resolution of 1280 pixel by 720 line, a frame rate of 24 fps, a 10-bit word and a YCbCr color space with 4:2:2 sampling. Such video has on average 20 bits per pixel and an overall bit rate of approximately 0.44 Gbps. Note that a technique (known as 3:2 pulldown) may be used to convert 24 frames per second film to 30 frames per second video. According to this technique, every other film frame is held for 3 video fields resulting in a sequence of 3 fields, 2 fields, 3 fields, 2 fields, etc. Such a technique is optionally used in an analog-to-digital conversion block other blocks.

According to an exemplary method, structuring optionally involves structuring some or all of the digital video data to a group or a series of individual digital image files on a frame-by-frame and/or other suitable basis. Of course, in an alternative, not every frame is converted. Note that an analog-to-digital conversion may also optionally perform such tasks. According to an exemplary structuring process, the converter structures a frame of digital video data to a digital image file and/or frames of digital video data to a digital video file. Suitable digital image file formats include, but are not limited to, the tag image file format (TIFF), which is a common format for exchanging raster graphics (bitmap) images between application programs. The TIFF format is capable of describing bilevel, grayscale, palette-color, and full-color image data in several color spaces.

Exemplary Encoders

As described above with reference to various exemplary converters and/or methods, an encoder or an encode block provides for compression of digital video data. Algorithmic processes for compression generally fall into two categories: lossy and lossless. For example, algorithms based on the discrete cosine transform (DCT) are lossy whereas lossless algorithms are not DCT-based. A baseline JPEG lossy process, which is typical of many DCT-based processes, involves encoding by: (i) dividing each component of an input image into 8×8 blocks; (ii) performing a two-dimensional DCT on each block; (iii) quantizing each DCT coefficient uniformly; (iv) subtracting the quantized DC coefficient from the corresponding term in the previous block; and (v) entropy coding the quantized coefficients using variable length codes (VLCs). Decoding is performed by inverting each of the encoder operations in the reverse order. For example, decoding involves: (i) entropy decoding; (ii) performing a 1-D DC prediction; (iii) performing an inverse quantization; (iv) performing an inverse DCT transform on 8×8 blocks; and (v) reconstructing the image based on the 8×8 blocks. While the process is not limited to 8×8 blocks, square blocks of dimension 2ⁿ×2ⁿ, where “n” is an integer, are preferred. A particular JPEG lossless coding process uses a spatial-prediction algorithm based on a two-dimensional differential pulse code modulation (DPCM) technique. The TIFF format supports a lossless Huffman coding process.

The TIFF specification also includes YCrCb, CMYK, RGB, CIE L*a*b* color space specifications. Data for a single image may be striped or tiled. A combination of strip-orientated and tile-orientated image data, while potentially possible, is not recommended by the TIFF specification. In general, a high resolution image can be accessed more efficiently—and compression tends to work better—if the image is broken into roughly square tiles instead of horizontally-wide but vertically-narrow strips. Data for multiple images may also be tiled and/or striped in a TIFF format; thus, a single TIFF format file may contain data for a plurality of images. In addition, TIFF format files are convertible to an audio video interleaved (AVI) format file, which is suitable for reception by an encoder or an encoding block. For example, an exemplary, non-limiting conversion block converts an AVI format file to a WINDOWS MEDIA™ format file and/or at least one data stream.

The AVI file format is a file format for digital video and audio for use with WINDOWS® OSs and/or other OSs. According to the AVI format, blocks of video and audio data are interspersed together. Although an AVI format file can have “n” number of streams, the most common case is one video stream and one audio stream. The stream format headers define the format (including compression) of each stream.

Referring again to FIGS. 1 through 3 and 5, a primary function of the encoding blocks 126, 526, 526′, 526″ is to compress digital video data. An encoder or encoding produces compressed digital video data in a particular format. Accordingly, an exemplary converter may store digital video data in a file or files and/or stream digital video data via a communication interface. One suitable, non-limiting format is the WINDOWS MEDIA™ format, which is a format capable of use in, for example, streaming audio, video and text from a server to a client computer. A WINDOWS MEDIA™ format file may also be stored locally. In general, a format may include more than just a file format and/or stream format specification. For example, a format may include codecs. Consider, as an example, the WINDOWS MEDIA™ format, which comprises audio and video codecs, an optional integrated digital rights management (DRM) system, a file container, etc. As referred to herein, a WINDOWS MEDIA™ format file and/or WINDOWS MEDIA™ format stream have characteristics of files suitable for use as a WINDOWS MEDIA™ format container file. Details of such characteristics are described below. In general, the term “format” as used for files and/or streams refers to characteristics of a file and/or a stream and not necessarily characteristics of codecs, DRM, etc. Note, however, that a format for a file and/or a stream may include specifications for inclusion of information related to codec, DRM, etc.

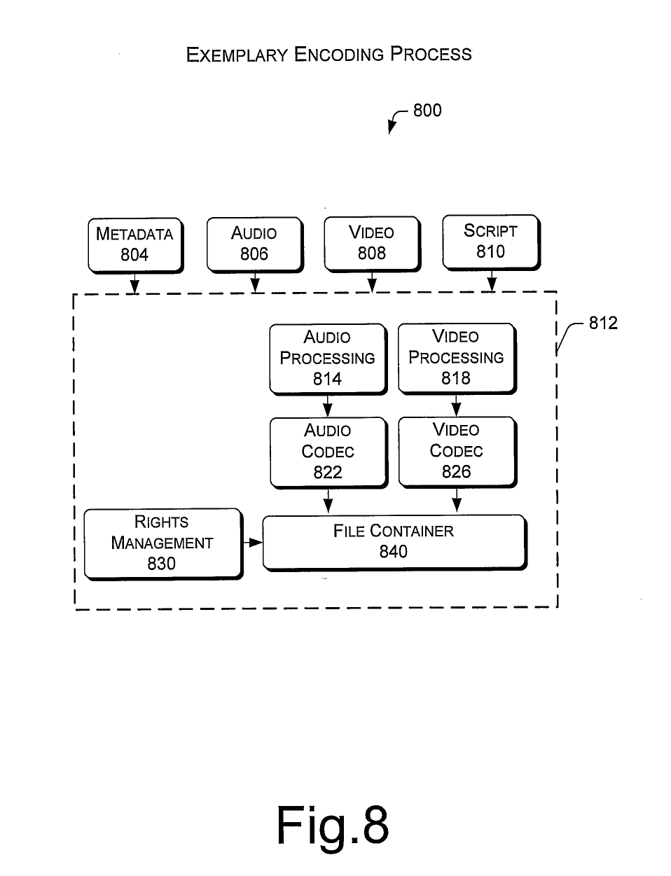

A block diagram of an exemplary encoding process for encoding digital data to a particular format 800 is shown in FIG. 8. Referring to FIG. 8, in the exemplary encoding process 800, an encoding block 812 accepts information from a metadata block 804, an audio block 806, a video block 808, and/or a script block 810. The information is optionally contained in an AVI format file and/or in a stream; however, the information may also be in an uncompressed WINDOWS MEDIA™ format or other suitable format. In an audio processing block 814 and in a video processing block 818, the conversion block 812 performs audio and/or video processing. Next, in an audio codec block 822 and in a video codec block 826, the conversion block 812 compresses the processed audio, video and/or other information and outputs the compressed information to a file container 840. Before, during and/or after processing and/or compression, a rights management block 830 optionally imparts information to the file container block 840 wherein the information is germane to any associated rights, e.g., copyrights, trademark rights, patent, etc., of the process or the accepted information.

The file container block 840 typically stores file information as a single file. Of course, information may be streamed in a suitable format rather than specifically “stored”. An exemplary, non-limiting file and/or stream has a WINDOWS MEDIA™ format. The term “WINDOWS MEDIA™ format”, as used thoughout, includes the active stream format and/or the advanced systems format, which are typically specified for use as a file container format. The active stream format and/or advanced systems format may include audio, video, metadata, index commands and/or script commands (e.g., URLs, closed captioning, etc.). In general, information stored in a WINDOWS MEDIA™ file container, will be stored in a file having a file extension such as .wma, .wmv, or .asf; streamed information may optionally use a same or a similar extension(s).

In general, a file (e.g., according to a file container specification) contains data for one or more streams that can form a multimedia presentation. Stream delivery is typically synchronized to a common timeline. A file and/or stream may also include a script, e.g., a caption, a URL, and/or a custom script command. As shown in FIG. 8, the conversion process 800 uses at least one codec or compression algorithm to produce a file and/or at least one data stream. In particular, such a process may use a video codec or compression algorithm and/or an audio codec or compression algorithm. Furthermore, an encoder and/or encoding block optionally supports compression and/or decompression processes that can utilize a plurality of processors, for example, to enhance compression, decompression, and/or execution speed of a file and/or a data stream.

One suitable video compression and/or decompression algorithm (or codec) is entitled MPEG-4 v3, which was originally designed for distribution of video over low bandwidth networks using high compression ratios (e.g., see also MPEG-4 v2 defined in ISO MPEG-4 document N3056). The MPEG-4 v3 decoder uses post processors to remove “blockiness”, which improves overall video quality, and supports a wide range of bit rates from as low as 10 kbps (e.g., for modem users) to 10 Mbps or more. Another suitable video codec uses block-based motion predictive coding to reduce temporal redundancy and transform coding to reduce spatial redundancy.

A suitable conversion software package that uses codecs is entitled WINDOWS MEDIA™ Encoder. The WINDOWS MEDIA™ Encoder software can compress live or stored audio and/or video content into WINDOWS MEDIA format files and/or data streams (e.g., such as the process 800 shown in FIG. 8). This software package is also available in the form of a software development kit (SDK). The WINDOWS MEDIA™ Encoder SDK is one of the main components of the WINDOWS MEDIA™ SDK. Other components include the WINDOWS MEDIA™ Services SDK, the WINDOWS MEDIA™ Format SDK, the WINDOWS MEDIA™ Rights Manager SDK, and the WINDOWS MEDIA™ Player SDK.

The WINDOWS MEDIA™ Encoder 7.1 software optionally uses an audio codec entitled WINDOWS MEDIA™ Audio 8 (e.g., for use in the audio codec block 322) and a video codec entitled WINDOWS MEDIA™ Video 8 codec (e.g., for use in the video codec block 326). The Video 8 codec uses block-based motion predictive coding to reduce temporal redundancy and transform coding to reduce spatial redundancy. Of course, later codecs, e.g., Video 9 and Audio 9, are also suitable. These aforementioned codecs are suitable for use in real-time capture and/or streaming applications as well as non-real-time applications, depending on demands. In a typical application, WINDOWS MEDIA™ Encoder 7.1 software uses these codecs to compress data for storage and/or streaming, while WINDOWS MEDIA™ Player software decompresses the data for playback. Often, a file or a stream compressed with a particular codec or codecs may be decompressed or played back using any of a variety of player software. In general, the player software requires knowledge of a file or a stream compression codec.

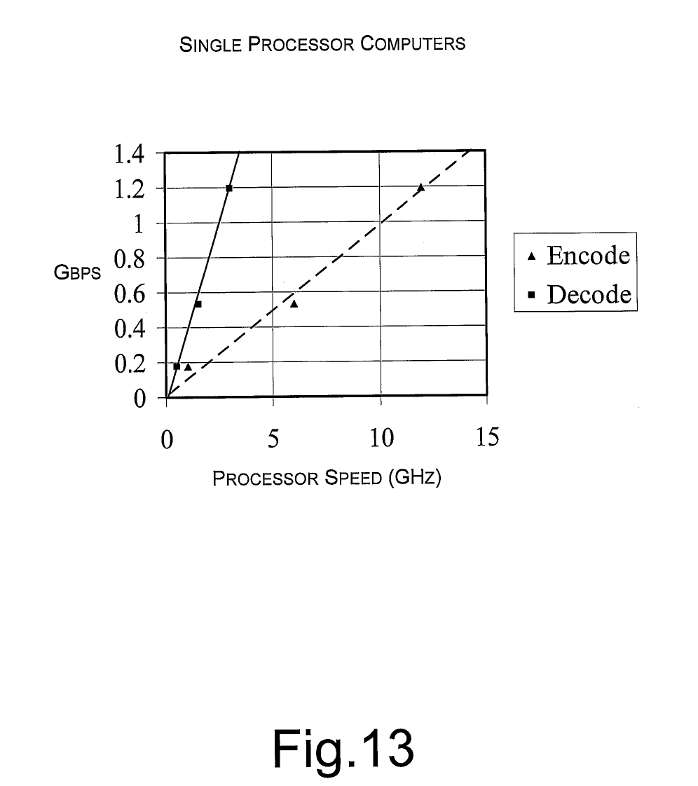

The Audio 8 codec is capable of producing a WINDOWS MEDIA™ format audio file of the same quality as a MPEG-1 audio layer-3 (MP3) format audio file, but at less than approximately one-half the size. While the quality of encoded video depends on the content being encoded, for a resolution of 640 pixel by 480 line, a frame rate of 24 fps and 24 bit depth color, the Video 8 codec is capable of producing 1:1 (real-time) encoded content in a WINDOWS MEDIA™ format using a computer having a processor speed of approximately 1 GHz. The same approximately 1 GHz computer would encode video having a resolution of 1280 pixel by 720 line, a frame rate of 24 fps and 24 bit depth color in a ratio of approximately 6:1 and a resolution of 1920 pixel by 1080 line, a frame rate of 24 fps and 24 bit depth color in a ratio of approximately 12:1 (see also the graph of FIG. 13 and the accompanying description). Essentially, the encoding process in these examples is processor speed limited. Thus, an approximately 6 GHz processor computer can encode video having a resolution of 1280 pixel by 720 line, a frame rate of 24 fps and 24 bit depth color in real-time; likewise, an approximately 12 GHz computer can encode video having a resolution of 1920 pixel by 1080 line, a frame rate of 24 fps and 24 bit depth color in real-time. Overall, the Video 8 codec and functional equivalents thereof are suitable for use in converting, streaming and/or downloading digital data. Of course, according to various exemplary methods, devices, systems and/or storage media described herein, video codecs other than the Video 8 may be used.

The WINDOWS MEDIA™ Encoder 7.1 supports single-bit-rate (or constant) streams and/or variable-bit-rate (or multiple-bit-rate) streams. Single-bit-rates and variable-bit-rates are suitable for some real-time capture and/or streaming of audio and video content and support of a variety of connection types, for example, but not limited to, 56 Kbps over a dial-up modem and 500 Kbps over a cable modem or DSL line. Of course, other higher bandwidth connections types are also supported and/or supportable. Thus, support exists for video profiles (generally assuming a 24 bit color depth) such as, but not limited to, DSL/cable delivery at 250 Kbps, 320×240, 30 fps and 500 Kbps, 320×240, 30 fps; LAN delivery at 100 Kbps, 240×180, 15 fps; and modem delivery at 56 Kbps, 160×120, 15 fps. The exemplary Video 8 and Audio 8 codecs are suitable for supporting such profiles wherein the compression ratio for video is generally at least approximately 50:1 and more generally in the range of approximately 200:1 to approximately 500:1 (of course, higher ratios and/or lower ratios are also possible). For example, video having a resolution of 320 pixel by 240 line, a frame rate of 30 fps and a color depth of 24 bits requires approximately 55 Mbps; thus, for DSL/cable delivery at 250 Kbps, a compression ratio of at least approximately 220:1 is required. Consider another example, a 1280×720, 24 fps profile at a color bit depth of 24 corresponds to a rate of approximately 0.53 Gbps. Compression of approximately 500:1 reduces this rate to approximately 1 Mbps. Of course, compression may be adjusted to target a specific rate or range of rates, e.g., 0.1 Mbps, 0.5 Mbps, 1.5 Mbps, 3 Mbps, 4.5 Mbps, 6 Mbps, 10 Mbps, 20 Mbps, etc. In addition, where bandwidth allows, compression ratios less than approximately 200:1 may be used, for example, compression ratios of approximately 30:1 or approximately 50:1 may be suitable. Of course, while an approximately 2 Mbps data rate is available over many LANs, even a higher speed LAN may require further compression to facilitate distribution to a plurality of users (e.g., at approximately the same time). Again, while these examples refer to the Video 8 and/or Audio 8 codecs, use of other codecs is also possible.

The Video 8 and Audio 8 codecs, when used with the WINDOWS MEDIA™ Encoder 7.1 may be used for capture, compression and/or streaming of audio and video content in a WINDOWS MEDIA™ format. Conversion of an existing video file(s) (e.g., AVI format files) to the WINDOWS MEDIA™ file format is possible with WINDOWS MEDIA™ 8 Encoding Utility software. The WINDOWS MEDIA™ 8 Encoding Utility software supports “two-pass” and variable-bit-rate encoding. The WINDOWS MEDIA™ 8 Encoding Utility software is suitable for producing content in a WINDOWS MEDIA™ format that can be downloaded and played locally.

As already mentioned, the WINDOWS MEDIA™ format optionally includes the active stream format and/or the advanced systems format. Various features of the active stream format are described in U.S. Pat. No. 6,041,345, entitled “Active stream format for holding multiple media streams”, issued Mar. 21, 2000, and assigned to Microsoft Corporation ('345 patent). The '345 patent is incorporated herein by reference for all purposes, particularly those related to file formats and/or stream formats. The '345 patent defines an active stream format for a logical structure that optionally encapsulates multiple data streams, wherein the data streams may be of different media (e.g., audio, video, etc.). The data of the data streams is generally partitioned into packets that are suitable for transmission over a transport medium (e.g., a network, etc.). The packets may include error correcting information. The packets may also include clock licenses for dictating the advancement of a clock when the data streams are rendered. The active stream format can facilitate flexibility and choice of packet size and bit rate at which data may be rendered. Error concealment strategies may be employed in the packetization of data to distribute portions of samples to multiple packets. Property information may also be replicated and stored in separate packets to enhance error tolerance.

In general, the advanced systems format is a file format used by WINDOWS MEDIA™ technologies and it is generally an extensible format suitable for use in authoring, editing, archiving, distributing, streaming, playing, referencing and/or otherwise manipulating content (e.g., audio, video, etc.). Thus, it is suitable for data delivery over a wide variety of networks and is also suitable for local playback. In addition, it is suitable for use with a transportable storage medium, as described in more detail below. As mentioned, a file container (e.g., the file container 840) optionally uses an advanced systems format, for example, to store any of the following: audio, video, metadata (such as the file's title and author), and index and script commands (such as URLs and closed captioning); which are optionally stored in a single file. Various features of the advanced systems format appear in a document entitled “Advanced Systems Format (ASF)” from Microsoft Corporation (Doc. Rev. 01.13.00e—current as of Jan. 23, 2002). This document is a specification for the advanced systems format and is available through the Microsoft Corporation Web site (www.microsoft.com). The “Advanced Systems Format (ASF)” document (sometimes referred to herein as the “ASF specification”) is incorporated herein by reference for all purposes and, in particular, purposes relating to encoding, decoding, file formats and/or stream formats.

An ASF file typically includes three top-level objects: a header object, a data object, and an index object. The header object is commonly placed at the beginning of an ASF file; the data object typically follows the header object; and the index object is optional, but it is useful in providing time-based random access into ASF files. The header object generally provides a byte sequence at the beginning of an ASF file (e.g., a GUID to identify objects and/or entities within an ASF file) and contains information to interpret information within the data object. The header object optionally contains metadata, such as, but not limited to, bibliographic information, etc.

An ASF file and/or stream may include information such as, but not limited to, the following: format data size (e.g., number of bytes stored in a format data field); image width (e.g., width of an encoded image in pixels); image height (e.g., height of an encoded image in pixels); bits per pixel; compression ID (e.g., type of compression); image size (e.g., size of an image in bytes); horizontal pixels per meter (e.g., horizontal resolution of a target device for a bitmap in pixels per meter); vertical pixels per meter (e.g., vertical resolution of a target device for a bitmap in pixels per meter); colors used (e.g., number of color indexes in a color table that are actually used by a bitmap); important colors (e.g., number of color indexes for displaying a bitmap); codec specific data (e.g., an array of codec specific data bytes).

The ASF also allows for inclusion of commonly used media types, which may adhere to other specifications. In addition, a partially downloaded ASF file may still function (e.g., be playable), as long as required header information and some complete set of data are available.

A computing environment of an exemplary camera and/or camera converter typically includes use of one or more multimedia file formats. As already mentioned, the advanced systems format (ASF) is suitable for use in a computing environment. Another exemplary multimedia file format is known as the advanced authoring format (AAF), which is an industry-driven, cross-platform, multimedia file format that can allow interchange of data between AAF-compliant applications. According to the AAF specification (see, e.g., Advanced Authoring Format Developers' Guide, Version 1.0, Preliminary Draft, 1999, which is available at http://aaf.sourceforge.net), “essence” data and metadata can be interchanged between compliant applications using the AAF. As defined by the AAF specification, essence data includes audio, video, still image, graphics, text, animation, music and other forms of multimedia data while metadata includes data that provides information on how to combine or modify individual sections of essence data and/or data that provides supplementary information about essence data. Of course, as used herein, metadata may include, for example, other information pertaining to operation of units and/or components in a computing environment. Further, metadata optionally includes information pertaining to business practices, e.g., rights, distribution, pricing, etc.

The AAF includes an object specification and a software development kit (SDK). The AAF Object Specification defines a structured container for storing essence data and metadata using an object-oriented model. The AAF Object Specification defines the logical contents of the objects and the rules for how the objects relate to each other. The AAF Low-Level Container Specification describes how each object is stored on disk. The AAF Low-Level Container Specification uses Structured Storage, a file storage system, to store the objects on disk. The AAF SDK Reference Implementation is an object-oriented programming toolkit and documentation that allows applications to access data stored in an AAF file. The AAF SDK Reference Implementation is generally a platform-independent toolkit provided in source form, it is also possible to create alternative implementations that access data in an AAF file based on the information in the AAF Object Specification and the AAF Low-Level Container Specification.

The AAF SDK Reference Implementation provides an application with a programming interface using the Component Object Model (COM). COM provides mechanisms for components to optionally interact independently of how the components are implemented. The AAF SDK Reference Implementation is provided generally as a platform-independent source code. AAF also defines a base set of built-in classes that can be used to interchange a broad range of data between applications. However, for applications having additional forms of data that cannot be described by the basic set of built-in classes, AAF provides a mechanism to define new classes that allow applications to interchange data that cannot be described by the built-in classes. Overall, an AAF file and an AAF SDK implementation can allow an application to access an implementation object which, in turn, can access an object stored in an AAF file.

Accordingly, various exemplary methods, devices, and/or systems optionally implement one or more multimedia formats and/or associated software to provide some degree of interoperability. An implementation optionally occurs within an exemplary converter and/or in a computing environment that extends beyond a camera and/or camera converter.

Referring again to software to facilitate encoding and/or decoding, as already mentioned, the WINDOWS MEDIA™ 8 Encoding Utility is capable of encoding content at variable bit rates. In general, encoding at variable bit rates may help preserve image quality of the original video because the bit rate used to encode each frame can fluctuate, for example, with the complexity of the scene composition. Types of variable bit rate encoding include quality-based variable bit rate encoding and bit-rate-based variable bit rate encoding. Quality-based variable bit rate encoding is typically used for a set desired image quality level. In this type of encoding, content passes through the encoder once, and compression is applied as the content is encountered. This type of encoding generally assures a high encoded image quality. Bit-rate-based variable bit rate encoding is useful for a set desired bit rate. In this type of encoding, the encoder reads through the content first in order to analyze its complexity and then encodes the content in a second pass based on the first pass information. This type of encoding allows for control of output file size. As a further note, generally, a source file must be uncompressed; however, compressed (e.g., AVI format) files are supported if an image compression manager (ICM) decompressor software is used.

Use of the Video 8 codec (or essentially any codec) due to compression and/or decompression computations places performance demands on a computer, in particular, on a computer's processor or processors. Demand variables include, but are not limited to, resolution, frame rate and bit depth. For example, a media player relying on the Video 8 codec and executing on a computer with a processor speed of approximately 0.5 GHz can decode and play encoded video (and/or audio) having a video resolution of 640 pixel by 480 line, a frame rate of approximately 24 fps and a bit depth of approximately 24. A computer with a processor of approximately 1.5 GHz could decode and play encoded video (and/or audio) having a video resolution of 1280 pixel by 720 line, a frame rate of approximately 24 fps and a bit depth of approximately 24; while, a computer with a processor of approximately 3 GHz could decode and play encoded video (and/or audio) having a video resolution of 1920 pixel by 1080 line, a frame rate of approximately 24 fps and a bit depth of approximately 24 (see also the graph of FIG. 14 and the accompanying description).

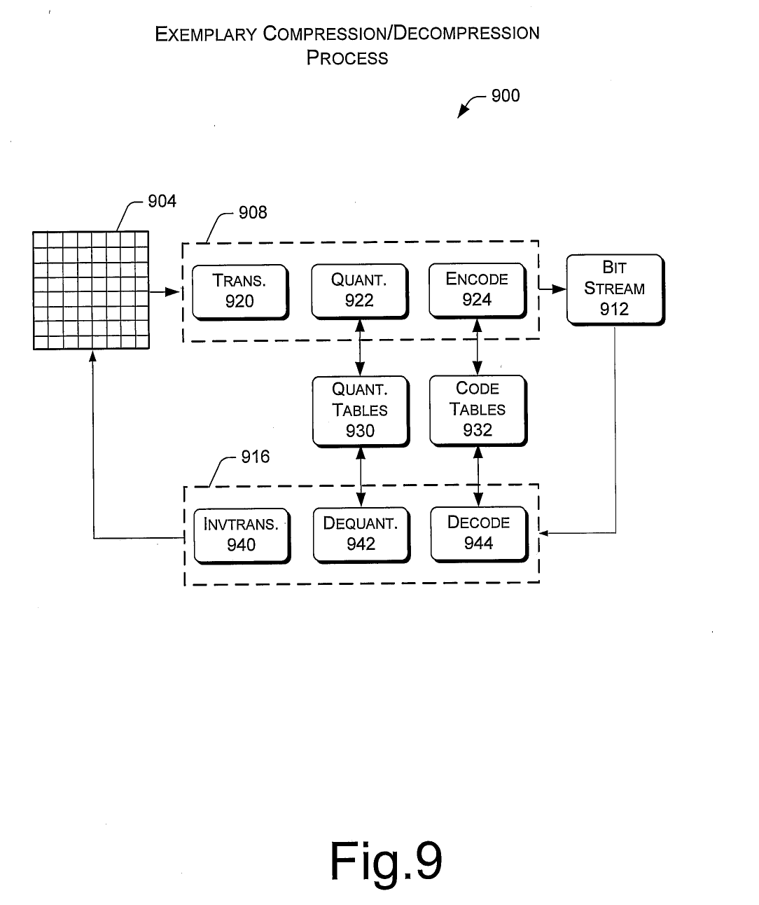

A block diagram of an exemplary compression and decompression process 900 is shown in FIG. 9. In this exemplary compression and decompression process 900, an 8 pixel×8 pixel image block 904 from, for example, a frame of a 1920 pixel×1080 line image, is compressed in a compression block 908, to produce a bit stream 912. The bit stream 912 is then (locally and/or remotely, e.g., after streaming to a remote site) decompressed in a decompression block 916. Once decompressed, the 8 pixel×8 pixel image block 904 is ready for display, for example, as a pixel by line image.

Note that the compression block 908 and the decompression block 916 include several internal blocks as well as a shared quantization table block 930 and a shared code table block 932 (e.g., optionally containing a Huffman code table or tables). These blocks are representative of compression and/or decompression process that use a DCT algorithm (as mentioned above) and/or other algorithms. For example, as shown in FIG. 9, a compression process that uses a transform algorithm generally involves performing a transform on a pixel image block in a transform block 920, quantizing at least one transform coefficient in a quantization block 922, and encoding quantized coefficients in a encoding block 924; whereas, a decompression process generally involves decoding quantized coefficients in a decoding block 944, dequantizing coefficients in a dequantization block 942, and performing an inverse transform in an inverse transform block 940. As mentioned, the compression block 908 and/or the decompression block 916 optionally include other functional blocks. For example, the compression block 908 and the decompression block 916 optionally include functional blocks related to image block-based motion predictive coding to reduce temporal redundancy and/or other blocks to reduce spatial redundancy. In addition, blocks may relate to data packets. Again, the WINDOWS MEDIA™ format is typically a packetized format in that a bit stream, e.g., the bit stream 912, would contain information in a packetized form. In addition, header and/or other information are optionally included wherein the information relates to such packets, e.g., padding of packets, bit rate and/or other format information (e.g., error correction, etc.). In general, various exemplary methods for producing a digital data stream produce a bit stream such as the bit stream 912 shown in FIG. 9.

Compression and/or decompression processes may also include other features to manage the data. For example, sometimes every frame of data is not fully compressed or encoded. According to such a process frames are typically classified, for example, as a key frame or a delta frame. A key frame may represent frame that is entirely encoded, e.g., similar to an encoded still image. Key frames generally occur at intervals, wherein each frame between key frames is recorded as the difference, or delta, between it and previous frames. The number of delta frames between key frames is usually determinable at encode time and can be manipulated to accommodate a variety of circumstances. Delta frames are compressed by their very nature. A delta frame contains information about image blocks that have changed as well motion vectors (e.g., bidirectional, etc.), or information about image blocks that have moved since the previous frame. Using these measurements of change, it might be more efficient to note the change in position and composition for an existing image block than to encode an entirely new one at the new location. Thus delta frames are most compressed in situations where the video is very static. As already explained, compression typically involves breaking an image into pieces and mathematically encoding the information in each piece. In addition, some compression processes optimize encoding and/or encoded information. Further, other compression algorithms use integer transforms that are optionally approximations of the DCT, such algorithms may also be suitable for use in various exemplary methods, devices, systems and/or storage media described herein. In addition, a decompression process may also include post-processing.

Exemplary Converter Including One or More Processor-Based Devices

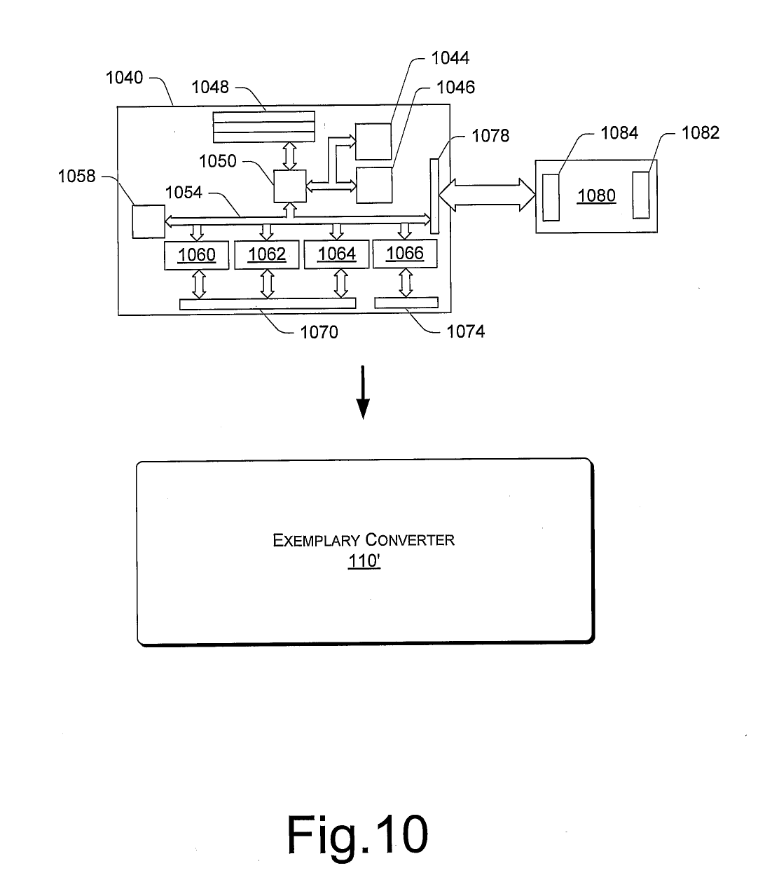

Referring to FIG. 10, a block diagram of an exemplary converter 110 that includes one or more processor-based devices 1040 is shown. Such an exemplary converter connects and/or attaches to a camera and/or is otherwise part of a camera. The exemplary converter 110 optionally includes features shown in various figures and/or described herein. The processor-based device 1040 is optionally a “single board computer” (SBC). For example, the device 1140 optionally includes features found on commercially available SBCs, such as, but not limited to, the GMS HYDRA V2P3 industrial SBC (General Micro Systems, Inc., Rancho Cucamonga, Calif.). The VME-based GMS HYDRA V2P3 SBC includes one or two PENTIUM® III processors with 512 KB of L2 cache per processor; a 100 MHz front side bus for cache and/or other memory operations; and 100 MHz memory block having three SDRAM DIMM modules for up to approximately 768 MB RAM. The GMS HYDRA V2P3 SBC also includes a PCI bus, one or more 10/100Base-Tx Ethernet ports, two serial ports, a SCSI port (e.g., Ultra-Wide SCSI, etc.), and flash BIOS ROM. In general, a VME 32 bit address bus has up to approximately 4 GB of addressable memory and can handle data transfer rates of approximately 40 MBps (approximately 320 Mbps) while a VME64 bus can handle data transfer rates of approximately 80 MBps (approximately 640 Mbps) and a VME64x bus can handle data transfer rates of approximately 160 MBps (approximately 1.28 Gbps). Of course, other VME buses corresponding to more advanced specifications (e.g., VME320 topology and 2eSST protocol bus cycle, etc.) are possible, which include data transfer rates of approximately 320 MBps (approximately 2.56 Gbps) or higher. The GMS HYRDA V2P3 supports VME operations under the WINDOWS® NT® OS with GMS-NT drivers, which provide for sustained data transfer rates of approximately 40 MBps (approximately 320 Mbps). In addition, with an additional transport layer (e.g., TCP/IP), the VME bus is transformable to a network. For example, the GMS VME NT® (“VME I/P”) provides a TCP/IP transport layer for the GMS NT®/2000 (“VME-Express”) driver and utilities. Use of an additional TCP/IP transport layer (e.g., the GMS VME I/P) allows TCP/IP network protocols to take place, which can eliminate Big/Little Endian and/or transfer size issues. Many VME-based devices include a VME-PCI interface or bridge. For example, the GMS OmniVME bridge is 2eSST and 64-bit, 66 MHz PCI 2.2 compliant and can handle data transfer rates up to approximately 533 MBps (approximately 4.3 Gbps).

Referring again to FIG. 10, the processor-based device 1040 includes one or more processors 1044, 1046; RAM 1048; one or more bridges 1050, 1054; and one or more PCI buses 1054. Additional communication paths are shown between the one or more processors 1144, 1146 and bridge 1050; further, the bridge 1050 includes communication paths to RAM 1048. An additional bridge 1058 is also shown and optionally has communication paths to other interfaces, memory, etc. as necessary. Also shown are a variety of interfaces 1060-1066 which are in communication with the PCI bus 1054. The interfaces 1060, 1062 are optionally Ethernet and/or other network interfaces (e.g., network I/Os). Thus, the interfaces 1060, 1062 optionally handle I/O for fast, gigabit and/or other Ethernet. The interface 1064 is optionally a SCSI and/or another serial and/or parallel interface. In addition, such interfaces and/or other interfaces, modules, buses, etc. (e.g., 1078) optionally communicate directly and/or indirectly with a storage block. As shown, the interfaces link to a respective connector or connectors 1070. The additional interface 1066 shown is optionally a PCI-VME interface, which links to a respective connector 1074. In addition, the PCI bus 1054 links to a connector 1078, such as, but not limited to, a PMC connector (e.g., PCI Mezzanine card) and/or PMC expansion module. A PMC expansion module typically contains features (e.g., logic, etc.) necessary to bridge a PCI bus, which can allow for configuration during a PCI “plug and play” cycle.

Also shown in FIG. 10, is a serial digital to PCI interface module and/or a serial digital to VME interface module 1080 in communication and/or part of the exemplary processor-based device 1040. This particular module 1080 includes a serial digital interface 1082 for receiving and/or transmitting serial digital data and a PCI interface 1084 for communication with a PCI bus of the device 1040, wherein communication includes receiving and/or transmitting of digital data, including digital video data. For example, a suitable commercially available serial digital to PCI interface module is the VideoPump module (Optibase, San Jose, Calif.). The VideoPump module has a serial digital interface for reception and/or transmission of digital video data (including audio data). The serial digital interface of VideoPump module complies with SMPTE 292M and SMPTE 259M video and SMPTE 299M and SMPTE 272M audio. The “host connection” of the VideoPump module complies with PCI bus 2.1 and 2.2 and can handle 33 MHz and 66 MHz clock domains, 32 bit and 64 bit transfers, and has automatic detection of PCI environment capabilities. The VideoPump module also operates in conjunction with WINDOWS® NT® and/or WINDOWS® 2000® OSs. The VideoPump module supports standard video formats of 1080i, 1080p, 1080sf (SMPTE 274M), 720p (SMPTE 296M) and NTSC serial digital 525 (SMPTE 259M), PAL 625 (ITU-R BT/CCIR 656-3). Of course, other modules, whether serial digital to PCI and/or serial digital to VME may be suitable for use with the processor-based device 1040 and/or other units of the exemplary converter 110. Further, such modules are optionally capable of operation as PCI to serial digital interfaces and/or VME to serial digital interfaces.

Thus, as described herein, an exemplary converter optionally includes one or more processor-based devices, such as the device 1040 and/or one or more serial digital interface modules, such as the module 1080. In an exemplary converter, an encoder includes a processor-based device (e.g., the device 1040) and optionally a serial digital interface module (e.g., the module 1080); a decoder includes a processor-based device (e.g., the device 1040) and optionally a serial digital interface module (e.g., the module 1080); a controller includes a processor-based device (e.g., the device 1040); and a server includes a processor-based device (e.g., the device 1040), optionally a serial digital interface module (e.g., the module 1080) and storage. Accordingly, such an exemplary converter can receive serial digital data via an encoder and/or a server; structure the digital data to produce structured digital data and/or compress the digital data to produce compressed digital data; and store the structured and/or compressed digital data to storage. Further, such an exemplary converter can, for example, through use of the decode unit, decode structured and/or compressed digital data and transmit the decoded digital data via a serial digital interface or display decoded digital data, as described below. In addition, control of an exemplary converter is optionally achieved through use of a controller that optionally controls various units via TCP/IP and/or other protocols. Further, the controller optionally controls various units using a framework. As already mentioned, such a framework typically includes object-oriented programming technologies and/or tools, which can further be partially and/or totally embedded. Such frameworks include, but are not limited to, the .NET® framework, the ACTIVEX® framework (Microsoft Corporation, Redmond, Wash.), and the JAVA® framework (Sun Microsystems, Inc., San Jose, Calif.). In general, such frameworks rely on a runtime engine for executing code.

An exemplary converter optionally includes capabilities for generating and/or communicating video and/or audio metadata (VAM). VAM are optionally processed along with video and/or audio data and/or stored. Exemplary converters having VAM capabilities optionally receive VAM via one interface and receive video and/or audio via one or more different interfaces. Further, exemplary converters having VAM capabilities optionally output VAM via one interface and output video and/or audio via one or more different interfaces. A variety of exemplary interfaces suitable for VAM are shown in the exemplary converter 110 of FIG. 1 and/or disclosed herein. An exemplary converter having VAM capabilities may also have a communication link (e.g., direct or indirect) to a server. For example, a server may transmit VAM to a converter and/or receive VAM from a converter. Such a server may also have communication links to other input devices and/or output devices.

Communication Via an Exemplary Network

As already mentioned, an exemplary encoder and/or encoding block optionally produces a bit stream capable of carrying variable-bit-rate and/or constant-bit-rate video and/or audio data in a particular format. Again, such bit streams are often measured in terms of bandwidth and in a transmission unit of kilobits per second (Kbps), millions of bits per second (Mbps) or billions of bits per second (Gbps). For example, an integrated services digital network line (ISDN) type T-1 can, at the moment, deliver up to 1.544 Mbps and a type E1 can, at the moment, deliver up to 2.048 Mbps. Broadband ISDN (BISDN) can support transmission from 2 Mbps up to much higher, but as yet unspecified, rates. Another example is known as digital subscriber line (DSL) which can, at the moment, deliver up to 8 Mbps. A variety of other examples exist, some of which can transmit at bit rates substantially higher than those mentioned herein. For example, Internet2 can support data rates in the range of approximately 100 Mbps to several gigabytes per second. Various exemplary converters and/or conversion methods optionally provides bit streams at a variety of rates, including, but not limited to, approximately 1.5 Mbps, 3 Mbps, 4.5 Mbps, 6 Mbps, and 10 Mbps. Such bit streams optionally include video data having a pixel by line format and/or a frame rate that corresponds to a common digital video format as listed in Table 1.

Communication to an Exemplary Recorder

In various exemplary methods, devices and/or systems, a converter (e.g., the converter 110 of FIG. 1, the converter 510 of FIG. 5) optionally transmits digital video data to a CD recorder and/or a DVD recorder. The CD and/or DVD recorder then records the data, which is optionally encoded or compressed and/or scaled to facilitate playback on a CD and/or DVD player. DVD players can typically play data at a rate of 10 Mbps; however, future players can be expected to play data at higher rates, e.g., perhaps 500 Mbps. In this particular example, the device scales the video data according to a DVD player specification (e.g., according to a data rate) and transmits the scaled data to a DVD recorder. The resulting DVD is then playable on a DVD player having the player specification. According to such a method, encoding or compression is not necessarily required in that scaling achieves a suitable reduction in data rate. In general, scaling is a process that does not rely on a process akin to compression/decompression (or encoding/decoding) in that information lost during scaling is not generally expected to be revived downstream. Where encoding or compression is used, a suitable compression ratio is used to fit the content onto a DVD disk or other suitable disk.

Methods, Devices, and/or Systems for Playback

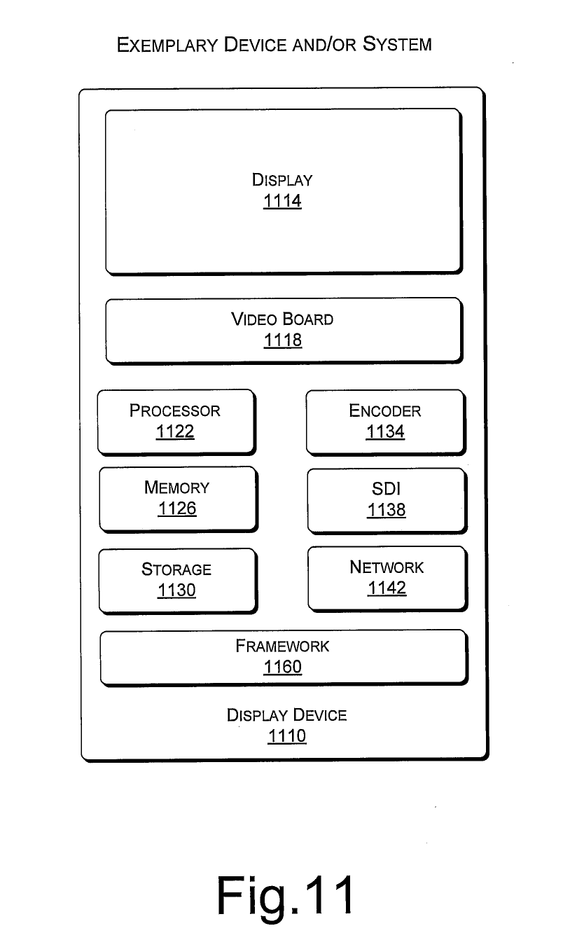

Once an encoded stream and/or file are delivered, a computing device having appropriate decompression (or decoding) software (e.g., WINDOWS MEDIA™ technology software) may play the video and/or audio information encoded in the encoded format stream and/or file. For example, FIG. 11 shows a block diagram of a display device 1110 having a variety of functional blocks. A display block 1114 includes a display (e.g., projector, LCD, CRT, etc.) capable of displaying decompressed digital video data. A video processing block 1118 includes a video board capable of converting decompressed digital video data to a format suitable for use with the display block 1114. A processor block 1122, a memory block 1126 and a storage block 1130 include a CPU, memory, and storage and are capable of operating in conjunction with each other for execution of software and/or for operation of hardware. Exemplary software includes browser software to enable the display device to communicate via a network and/or locate an address, for example, corresponding to a converter device capable of communicating compressed digital data. The decompressor block 1134 includes decompression software for execution in conjunction with the processor block 1122 and the memory block 1126. In general, the processor block 1122 directs decompressed digital video data to the video processing block 1118. The video processing block 1118 typically includes additional memory (e.g., RAM, etc.) to facilitate display of video data. A SDI block 1138 and/or a network interface block 1142 serve as communication interfaces for receiving compressed digital data. In addition, the display device optionally has an address such that it can be located via a network.

The exemplary display device 1110, as shown, also includes framework capabilities 1160. Hence, an exemplary method of using such a display device optionally includes requesting and/or receiving of code from a controller and/or other device. For example, an exemplary display device may request a control command from a controller wherein the command specifies receiving, conversion, structuring, decompression, storage and/or communication parameters. In turn, a controller may transmit code to the exemplary display device where, upon receipt, the display device executes the code using framework capabilities.

The exemplary display device 1110 also optionally includes features of the exemplary converter 110 of FIG. 1. For example, the display device 1110 optionally includes one or more computing device (e.g., the device 1080) and/or I/O module (e.g., the module 1080).

An exemplary method for using a display device, such as, but not limited to, the display device 1110, includes receiving compressed digital video data, decompressing the compressed digital video data and displaying the decompressed digital video data. According to this exemplary method, digital data optionally include video data having an image and/or frame rate format selected from the common video formats listed in Table 1, for example, the digital data optionally has a 1280 pixel by 720 line format, a frame rate of 24 fps and a bit depth of approximately 24. In this exemplary method, the display device includes a processor, such as, but not limited to, a PENTIUM® processor (Intel Corporation, Delaware) having a speed of 1.4 GHz (e.g., a PENTIUM® III processor). Consider another example wherein the digital data optionally has a 1920 pixel by 1080 line image formats a frame rate of 24 fps and a bit depth of approximately 24 bits. Yet another exemplary display device has two processors, wherein each processor has a speed of greater than 1.2 GHz, e.g., two AMD® processors (Advanced Micro Devices, Incorporated, Delaware). In general, a faster processor speed allows for display of a higher resolution image format and/or a higher frame rate.

Regarding the display block 1114, recently, new specifications have arisen that include, but are not limited to, super extended graphics array (SXGA) and ultra extended graphics array (UXGA). The SXGA specification is generally used in reference to screens with 1280×1024 resolution; UXGA refers to a resolution of 1600 by 1200. The older specifications (VGA and SVGA) are often used simply in reference to their typical resolution capabilities. The Table 2, below, shows display modes and the resolution levels (in pixels horizontally by lines vertically) most commonly associated with each.

TABLE 2
Exemplary video display system specifications

| System | Pixel by Line Resolution |
|---|---|
| VGA | 640 by 480 |
| SVGA | 800 by 600 |
| XGA | 1024 by 768 |
| SXGA | 1280 by 1024 |
| UXGA | 1600 by 1200 |

Exemplary Systems

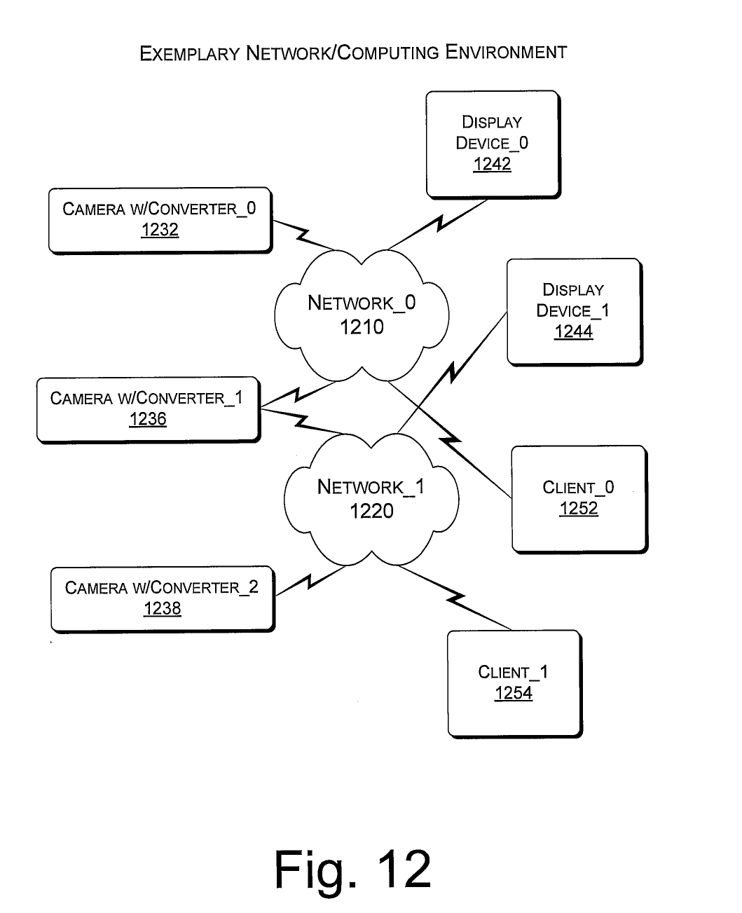

A block diagram of an exemplary system 1200 is shown in FIG. 12. The system includes two networks, Network_0 (1210) and Network_1 (1220), which are optionally independent and/or optionally have different bandwidth limitations (e.g., due to architecture, traffic, etc.). Various cameras, display devices and clients are connected to Network_0 (1210) and Network_1 (1220). Shown in FIG. 12 are three cameras with converters, Camera w/Converter_0 (1232), Camera w/Converter_1 (1236) and Camera w/Converter_2 (1238); two clients, Client_0 (1252) and Client_1 (1254); and two display devices, Display_Device_0 (1242) and Display_Device_1 (1244). Camera w/Converter_0 (1232) and Camera w/Converter_1 (1236) communicate with Network_0 (1210) while Camera w/Converter_1 (1236) and Camera w/Converter_2 (1238) communicate with Network_1 (1220). Client_0 (1252) and Display Device_0 (1242) communicate with Network_0 (1210) while Client_1 (1254) and Display Device_1 (1244) communicate with Network_1 (1220). In this manner, compressed digital video data is communicable from a camera with a converter to a client and/or a display device via one or more networks. In addition, a camera with a converter, a client, and/or a display device are optionally locatable via one or more networks using addresses.

Encoding and/or Decompression Speed

FIG. 13 is a graph of bit rate in Gbps (ordinate, y-axis) versus processor speed for a computer having a single processor (abscissa, x-axis). The graph shows data for encoding video and for decoding video. Note that the data points lay along approximately straight lines in the x-y plane (a solid line is shown for decoding and a dashed line is shown for encoding). A regression analysis shows that decoding has a slope of approximately 0.4 Gbps per GHz processor speed and that encoding has a slope of approximately 0.1 Gbps per GHz processor speed. In this particular graph, it is apparent that, with reference to the foregoing discussion, that resolution, frame rate and color space need not adhere to any specific format and/or specification. The ordinate data was calculated by multiplying a pixel resolution number by a line resolution number to arrive at the number of pixels per frame and then multiplying the pixels per frame number by a frame rate and the number of color information bits per pixel. Thus, according to various exemplary methods, devices and/or systems described herein, encoding and/or decoding performance characteristics, if plotted in a similar manner would produce data lying approximately along the respective lines as shown in FIG. 13. Thus, according to various aspects of exemplary methods, devices and/or systems described herein, a computer having an approximately 1.5 GHz processor has can decode encoded video at a rate of approximately 0.6 Gbps, e.g., 1.5 GHz multiplied by 0.4 Gbps/GHz, and therefore, handle video having a display rate of approximately 0.5 Gbps, e.g., video having a resolution of 1280 pixel by 720 line, a frame rate of 24 frames per second and a color bit depth of 24 bits. Note that for decoding, the rate is given based on a video display format and not on the rate of data into the decoder. In addition, while the abscissa of the graph in FIG. 13 terminates at 15 GHz, predictions based on Moore's Law suggest that processor speeds in excess of 15 GHz can be expected; thus, such processors are also within the scope of the exemplary methods, systems, devices, etc. disclosed herein.

Video Quality

Various exemplary methods, devices, systems, and/or storage media discussed herein are capable of providing quality equal to or better than that provided by MPEG-2, whether for DTV, computers, DVDs, networks, etc. One measure of quality is resolution. Regarding MPEG-2 technology, most uses are limited to 720 pixel by 480 line (345,600 pixels) or 720 pixel by 576 line (414,720 pixels) resolution. In addition, DVD uses are generally limited to approximately 640 pixel by 480 line (307,200 pixels). Thus, any technology that can handle a higher resolution will inherently have a higher quality. Accordingly, various exemplary methods, devices, systems, and/or storage media discussed herein are capable of handling a pixel resolution greater than 720 pixels and/or a line resolution greater than approximately 576 lines. For example, a 1280 pixel by 720 line resolution has 921,600 pixels, which represents over double the number of pixels of the 720 pixel by 576 line resolution. When compared to 640 pixel by 480 line, the increase is approximately 3-fold. On this basis, various exemplary methods, devices, systems, and/or storage media achieve better video quality than MPEG-2-based methods, devices, systems and/or storage media.

Another quality measure involves measurement of peak signal to noise ratio, known as PSNR, which compares quality after compression/decompression with original quality. The MPEG-2 standard (e.g., MPEG-2 Test Model 5) has been thoroughly tested, typically as PSNR versus bit rate for a variety of video. For example, the MPEG-2 standard has been tested using the “Mobile and Calendar” reference video (ITU-R library), which is characterized as having random motion of objects, slow motion, sharp moving details. In a CCIR 601 format, for MPEG-2, a PSNR of approximately 30 dB results for a bit rate of approximately 5 Mbps and a PSNR of approximately 27.5 dB for a bit rate of approximately 3 Mbps. Various exemplary methods, devices, systems, and/or storage media are capable of PSNRs higher than those of MPEG-2 given the same bit rate and same test data.

Yet another measure of quality is comparison to VHS quality and DVD quality. Various exemplary methods, devices, systems, and/or storage media are capable of achieving DVD quality for 640 pixel by 480 line resolution at bit rates of 500 kbps to 1.5 Mbps. To achieve a 500 kbps bit rate, a compression ratio of approximately 350:1 is required for a color depth of 24 bits and a compression ration of approximately 250:1 is required for a color depth of 16 bits. To achieve a 1.5 Mbps bit rate, a compression ratio of approximately 120:1 is required for a color depth of 24 bits and a compression ratio of approximately 80:1 is required for a color depth of 16 bits. Where compression ratios appear, one would understand that a decompression ratio may be represented as the reverse ratio.

Yet another measure of performance relates to data rate. For example, while a 2 Mbps bit rate-based “sweet spot” may exist (e.g., for a resolution of 352 pixel by 480 line), MPEG-2 is not especially useful at data rates below approximately 4 Mbps. For most content a data rate below approximately 4 Mbps typically corresponds to a high compression ratio, which explains why MPEG-2 is typically used at rates greater than approximately 4 Mbps (to approximately 30 Mbps) when resolution exceeds, for example, 352 pixel by 480 line. Thus, for a given data rate, various exemplary methods, devices, systems, and/or storage media are capable of delivering higher quality video. Higher quality may correspond to higher resolution, higher PSNR, and/or other measures.

Various exemplary methods, devices, systems and/or storage media are optionally suitable for use with games. In addition, various exemplary methods, devices, systems and/or storage media are optionally suitable for use with exemplary methods, devices, systems, etc., disclosed in a related application entitled “Video appliance”, to inventors Thomas Algie Abrams, Jr. and Mark Beauchamp, having Ser. No. 10/115,681 and attorney Docket No. MS1-1082US, the contents of which are incorporated by reference herein.

While the description herein generally refers to “video” many formats discussed herein also support audio. Thus, where appropriate, it is understood that audio may accompany video. Although some exemplary methods, devices and exemplary systems have been illustrated in the accompanying Drawings and described in the foregoing Detailed Description, it will be understood that the methods and systems are not limited to the exemplary embodiments disclosed, but are capable of numerous rearrangements, modifications and substitutions without departing from the spirit set forth and defined by the following claims.

What is claimed is:

1. A display device for displaying video, the device comprising:
a LCD display for display of decompressed digital video;
a video board to output decompressed digital video to the LCD display;
a processor;
memory;
decompression software for execution in conjunction with the processor and the memory to decompress compressed digital video data;
an interface to receive compressed digital video data and to receive code wherein the code comprises a command that specifies one or more parameters for at least one member selected from the group consisting of receiving, converting, structuring, decompressing, storing and communicating digital video data;
an Internet protocol address; and
framework capabilities that comprise a runtime engine for execution of the code received by the interface.

2. The display device of claim 1 wherein the LCD display has a resolution of at least 640 pixels by 480 lines.

3. The display device of claim 1 wherein the video board comprises random access memory.

4. The display device of claim 1 further comprising browser software for execution in conjunction with the processor and the memory.

5. The display device of claim 4 wherein the browser software provides for communication via a network.

6. The display device of claim 4 wherein the browser software provides for locating a network address.

7. The display device of claim 4 wherein the browser software provides for locating a device capable of communicating compressed digital video data to the display device.

8. The display device of claim 1 comprising a serial digital interface.

9. The display device of claim 1 wherein the runtime engine acts as an interface between applications and an operating system.

10. The display device of claim 1 wherein the framework capabilities comprise associated classes.

11. The display device of claim 10 wherein the classes comprise one or more classes that facilitate execution of one or more graphical user interfaces for display on the LCD display.

12. The display device of claim 10 wherein the classes comprise one or more classes that enable XML data manipulation.

13. The display device of claim 10 wherein the classes comprise one or more classes that enable XML searching.

14. The display device of claim 10 wherein the classes comprise one or more classes that provide functionality selected from a group consisting of input/output, string manipulation, security management, network communications, thread management, text management, and persistent data management.

15. The display device of claim 10 wherein the classes comprise one or more SQL classes for manipulating persistent data stores.

16. The display device of claim 1 wherein the interface receives portable executable code.

17. The display device of claim 1 wherein the device comprises a plurality of processors.

18. A method, implemented by a display device, the method comprising:
requesting one or more control command parameters from a controller or other device wherein the one or more control command parameters relate to digital video data;
in response to the request, receiving code;
executing the code on a runtime engine of the display device to implement the one or more control command parameters; and
according to the one or more control command parameters, using the display device to decompress the compressed digital video data and to display the decompressed digital video data.

19. The method of claim 18 wherein the requesting comprises requesting via a network and wherein the receiving code comprises receiving code via the network.

20. A method of controlling a display device comprising:
receiving an executable file and/or code via a network interface;
receiving video data via a serial digital interface;
executing the executable file and/or code on a runtime engine;
processing the video data based at least in part on the executing to produce processed video data; and
displaying the processed video data.
